(19) United States
(12) Patent Application Publication
(10) Pub. No.: US 2016/0080451 A1
(43) Pub. Date: Mar. 17, 2016

(54) REAL-TIME DYNAMIC HYPERLINKING SYSTEM AND METHOD

(71) Applicant: Gazoo, Inc., Bryan, TX (US)

(72) Inventors: Joseph Scott Morton, College Station, TX (US); Christopher Michael McDonald, Bryan, TX (US); Glenn Donald Knepp, College Station, TX (US)

(73) Assignee: Gazoo, Inc., Bryan, TX (US)

(21) Appl. No.: 14/949,135

(22) Filed: Nov. 23, 2015

Related U.S. Application Data
(63) Continuation-in-part of application No. 14/642,639, filed on Mar. 9, 2015, now Pat. No. 9,197,697.
(60) Provisional application No. 61/950,289, filed on Mar. 10, 2014.

(51) Int. Cl. H04L 29/06; H04N 21/845; H04N 21/858; H04L 29/08; H04N 21/414

(52) U.S. Cl. CPC H04L 65/602; H04L 67/02; H04N 21/41407; H04N 21/858; H04N 21/8456; H04N 21/8455

(57) ABSTRACT

A system and method enabling real-time dynamic hyperlinking of software applications and resources within mobile devices is disclosed. The system/method virtualizes the graphical user experience (GEX) and user input experience (UEX) that comprise the graphical user interface (GUI) for host application software (HAS) running on a host computer system (HCS). The virtualized GUI (VUI) GEX component is converted to a remote video stream (RVS) and communicated to a remote mobile computing device (MCD) over a computer communication network (CCN). A MCD thin client application (TCA) receives the RVS and presents this GEX content on the MCD display using a graphics experience mapper (GEM). A RVS frame scope (RFS) of real-time user-selected RVS frame regions may be dynamically transmitted by the TCA to the HCS which then translates the associated RFS into a hyperlink associated with known and/or searched images that are matched to the RFS.

### CROSS REFERENCE TO RELATED APPLICATIONS

### Continuation-in-Part Patent Application (CIP)

This is a Continuation-In-Part patent application (CIP) of and incorporates by reference United States Utility patent application for CLOUD COMPUTING SYSTEM AND METHOD by inventors Joseph Scott Morton, Christopher Michael McDonald, and Glenn Donald Knepp, filed electronically with the USPTO on Mar. 9, 2015, with Ser. No. 14/642,639, EFS ID 21718675, confirmation number 1436, docket AZGAZ.0101, and issued as U.S. Pat. No. 9,197,697 on Nov. 24, 2015.

### U.S. Utility Patent Applications

This application claims benefit under 35 U.S.C. §120 and incorporates by reference United States Utility patent application for CLOUD COMPUTING SYSTEM AND METHOD by inventors Joseph Scott Morton, Christopher Michael McDonald, and Glenn Donald Knepp, filed electronically with the USPTO on Mar. 9, 2015, with Ser. No. 14/642,639, EFS ID 21718675, confirmation number 1436, docket AZGAZ.0101.

### U.S. Provisional Patent Applications

This application claims benefit under 35 U.S.C. §119 and incorporates by reference United States Provisional patent application for CLOUD COMPUTING SYSTEM AND METHOD by inventors Joseph Scott Morton, Christopher Michael McDonald, and Glenn Donald Knepp, filed electronically with the USPTO on Mar. 10, 2014, with Ser. No. 61/950,289, EFS ID 18414620, confirmation number 2283, docket AZGAZ.0101P.

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present invention generally relates to cloud computing systems and methods for deploying host computer system (HCS) software applications to a mobile computing device (MCD). More specifically and without limitation the present invention permits virtualizing enterprise-class software applications to MCD environments via the use of a thin-client MCD software application in contexts where the computer communication network (CCN) linking the HCS and MCD is of low bandwidth and/or the MCD is of limited processing power.

### PRIOR ART AND BACKGROUND OF THE INVENTION

### Prior Art

The deployment of cloud computing services typically involves the presentation of host application software (HAS) by a host computer system (HCS) to a remote computing device (RCD) which may be in some circumstances a mobile computing device (MCD) such as a computer tablet or smartphone. The deployment of software applications to the RCD/MCD platform can be problematic for several reasons including:
The MCD may have insufficient resources to run the HAS.
The MCD may have insufficient processing power to run the HAS.
The MCD may have insufficient communication bandwidth to provide responsive access to the HAS.
The MCD may not have hardware compatible with the HCS operating environment (missing keyboard, mouse, or other user input device).
   All of these issues may result in a poor user experience with the HCS/HAS combination and in many circumstances prevent the HAS from being capable of deployment in a MCD environment.

The typical approaches to HAS deployment to remote computing devices includes the use of a web browser interface on the HCS as an access portal to the HAS or the use of a virtual private network (VPN) that links the MCD to the HCS over a secure network interface. Both of these approaches suffer from significant performance limitations in that they require a large communication overhead between the HCS and MCD to maintain a real-time view of the display screen that is simulated by the HCS for the purposes of providing a virtualized display for the HAS. MCDs having limited processing power or limited communication bandwidth to the HCS suffer in these circumstances because these limitations result in poor application responsiveness and a resulting poor user experience.

Additionally, the large communication overhead associated with VPN methodologies (especially in situations where the video display experiences a high rate of change or where user input such as keyboard or mouse input is common) results in higher communication costs for MCDs using this form of interface. High frame rate updates by a typical VPN remote console simulator often result in very high communication link bandwidth utilization between the HCS and MCD and cannot be supported in situations where the communication link bandwidth is limited. All of these drawbacks may be cost/performance prohibitive in situations where the end user has limited financial and hardware means.

### Deficiencies in the Prior Art

The prior art as detailed above suffers from the following deficiencies:
Prior art cloud computing systems and methods typically require a minimum CCN bandwidth to virtualize the HSC environment on the mobile device.
Prior art cloud computing systems and methods typically lack responsiveness in situations where the CCN bandwidth is limited.
Prior art cloud computing systems and methods typically consume considerable CCN bandwidth in virtualizing the HSC environment to the mobile device.
Prior art cloud computing systems and methods typically lack responsiveness in situations where the MCD processing power is limited.
Prior art cloud computing systems and methods typically require significant software application development to occur on the MCD to support the virtualized HCS environment.
Prior art cloud computing systems and methods typically have difficulty in maintaining security for virtualized HCS environments supported by MCD hardware.
Prior art cloud computing systems and methods require the use of a virtual private network (VPN) to maintain security between the HCS and MCD.
Prior art cloud computing systems and methods typically have difficulty in porting the visual content of the HSC application to the MCD display environment.

While some of the prior art may teach some solutions to several of these problems, the core deficiencies in the prior art systems have not been addressed.

### OBJECTIVES OF THE INVENTION

Accordingly, the objectives of the present invention are (among others) to circumvent the deficiencies in the prior art and affect the following objectives:
(1) Provide for a cloud computing system and method that requires minimum CCN bandwidth to virtualize the HSC environment on the mobile device.
(2) Provide for a cloud computing system and method that provides user responsiveness in situations where the CCN bandwidth is limited.
(3) Provide for a cloud computing system and method that consumes minimal CCN bandwidth in virtualizing the HSC environment to the mobile device.
(4) Provide for a cloud computing system and method that is responsive in situations where the MCD processing power is limited.
(5) Provide for a cloud computing system and method that requires minimum software application development to occur on the MCD to support the virtualized HCS environment.
(6) Provide for a cloud computing system and method that maintains security for virtualized HCS environments supported by MCD hardware.
(7) Provide for a cloud computing system and method that does not require the use of a virtual private network (VPN) to maintain security between the HCS and MCD.
(8) Provide for a cloud computing system and method that seamlessly ports the visual content of the HSC application to the MCD display environment.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

The present invention supports the deployment of cloud computing host software applications (HAS) and content to a mobile computing device (MCD) from a host computer system (HCS) over a computer communication network (CCN). In an exemplary invention system embodiment the HCS is configured with conventional host operating system software (HOS) that supports execution of the HAS. This HOS is equipped with a virtualized graphical user interface (VUI) device driver that is configured to virtualize the graphical user experience (GEX) and user input experience (UEX) associated with the HAS as it is executed on the HCS. The VUI permits the HAS to operate transparently on the HCS and appear as if it is operating in a standalone computer environment.

The VUI is configured to translate the GEX into a remote video stream (RVS). This RVS may be contained in one or more compressed video formats to minimize the effective bandwidth of transmitting this application display image. The HCS is configured to transmit the RVS to the MCD over the CCN. The MCD further comprises a thin client application (TCA) that implements a graphics experience mapper (GEM) and user experience mapper (UEM). The GEM is configured to receive the RVS and present the RVS to a display on the MCD. Simultaneously, the UEM is configured to accept user input data (UID) entered on the MCD and translate the UID to an equivalent UEX protocol. This equivalent UEX protocol is then transmitted by the TCA to the VUI for presentation to the HAS through the HCS. In this manner, the user input capabilities of the MCD are mapped to equivalent UEX protocols that are understood by the HAS.

By utilizing streamed video rather than transmitting display images frame-by-frame from the HCS to the MCD, the bandwidth requirements for hosting the HAS on the MCD are drastically reduced, as the HCS can implement the HAS locally and merely provide a thin-client audio/video/keyboard/mouse interface to the MCD via translation services performed by the VUI (GEX,UEX) and TCA (GEM,UEM).

### BRIEF DESCRIPTION OF THE DRAWINGS

For a fuller understanding of the advantages provided by the invention, reference should be made to the following detailed description together with the accompanying drawings wherein:

FIG. 1 illustrates an overview block diagram depicting a preferred exemplary invention system embodiment;

FIG. 2 illustrates an overview flowchart depicting a preferred exemplary invention method embodiment;

FIG. 3 illustrates a detail block diagram depicting a preferred exemplary invention system embodiment;

FIG. 4 illustrates a detail flowchart depicting a preferred exemplary invention method embodiment;

FIG. 5 illustrates a variety of exemplary TCA components that may operate in various embodiments of the present invention;

FIG. 6 illustrates the use of steganographic data encapsulation within the video stream transmitted to the MCD;

FIG. 7 illustrates an exemplary invention embodiment data flow diagram depicting user experience mapper (UEM) coordination on the MCD with user input experience translation (UEX) on the HCS;

FIG. 8 illustrates an exemplary invention embodiment as applied to AMAZON® APPSTREAM SERVICES;

FIG. 9 illustrates an overview system block diagram of a presently preferred invention system embodiment employing a custom host server (CHS) hardware platform incorporating multicore processors;

FIG. 10 illustrates an overview system block diagram of a presently preferred invention system embodiment employing a custom host server (CHS) hardware platform incorporating multicore processors illustrating overall data flows;

FIG. 11 illustrates a detail system block diagram of a presently preferred invention system embodiment employing host machines incorporating multicore processors;

FIG. 12 illustrates a detail system block diagram of a presently preferred invention system embodiment employing virtual machines incorporating control and dispatch to multicore parallel processors;

FIG. 13 illustrates a block diagram depicting an exemplary embodiment of the present invention implementing a real-time dynamic hyperlinking system;

FIG. 14 illustrates a flowchart depicting an exemplary embodiment of the present invention implementing a real-time dynamic hyperlinking method;

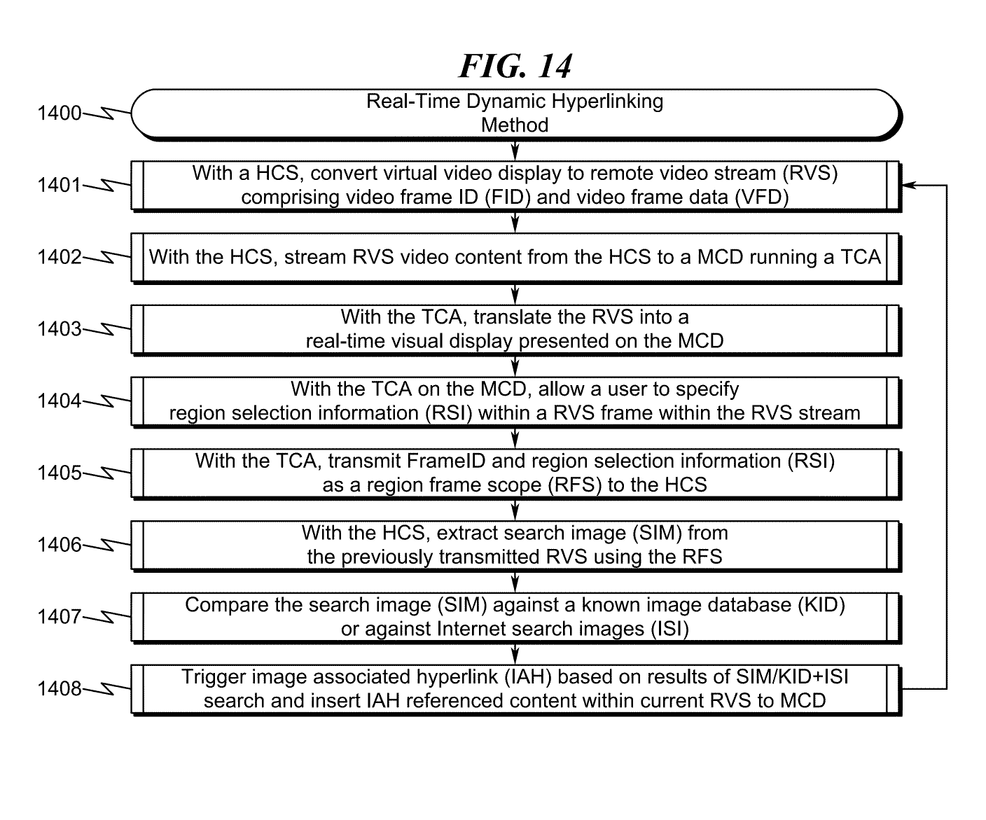

FIG. 15 illustrates a HCS-to-MCD data flow diagram depicting an exemplary embodiment of the present invention implementing real-time dynamic hyperlinking;

FIG. 16 illustrates a MCD-to-HCS data flow diagram depicting an exemplary embodiment of the present invention implementing real-time dynamic hyperlinking;

FIG. 17 illustrates a top right perspective view of an exemplary MCD and time-stacked RVS video frames;

FIG. 18 illustrates a top left perspective view of an exemplary MCD and time-stacked RVS video frames;

FIG. 19 illustrates a top right perspective view of an exemplary MCD and time-stacked RVS video frames with RFS sub-image selection filter frame;

FIG. 20 illustrates a top left perspective view of an exemplary MCD and time-stacked RVS video frames with RFS sub-image selection filter frame;

FIG. 21 illustrates a top view of an exemplary MCD and time-stacked RVS video frames with RFS sub-image selection filter frame depicting the area of RVS sub-image selection;

FIG. 22 illustrates a side perspective view of an exemplary MCD and time-stacked RVS video frames with RFS sub-image selection filter frame depicting the item selection within the RVS sub-image;

FIG. 23 illustrates a top right perspective view of an exemplary MCD and selected item within a RVS video frame in conjunction with a selection result overlay depicting image search results based on the selected RVS sub-image;

FIG. 24 illustrates a top left perspective view of an exemplary MCD and selected item within a RVS video frame in conjunction with a selection result overlay depicting image search results based on the selected RVS sub-image;

FIG. 25 illustrates a top right perspective view of a mobile phone with RFS incorporating an Image Origin Reference (IOR) in which the user selects a coordinate on the MCD display that is associated with either a fixed radial distance or a radial distance selected by the user via a gesture or other MCD input;

FIG. 26 illustrates a top left perspective view of a mobile phone with RFS incorporating an Image Origin Reference (IOR) in which the user selects a coordinate on the MCD display that is associated with either a fixed radial distance or a radial distance selected by the user via a gesture or other MCD input;

FIG. 27 illustrates a top right perspective view of a mobile phone with RFS incorporating an Image Elliptical Region (IER) in which the user selects a coordinate on the MCD display that is associated with either a fixed elliptical shape or an ellipses perimeter selected by the user via a gesture or other MCD input;

FIG. 28 illustrates a top left perspective view of a mobile phone with RFS incorporating an Image Elliptical Region (IER) in which the user selects a coordinate on the MCD display that is associated with either a fixed elliptical shape or an ellipses perimeter selected by the user via a gesture or other MCD input;

FIG. 29 illustrates a top right perspective view of a mobile phone with RFS incorporating an Image Peripheral Outline (IPO) in which the user selects an item on the MCD display and the HCS (or optionally the MCD) automatically selects a perimeter edge of the image selected to determine the extent of the RFS;

FIG. 30 illustrates a top left perspective view of a mobile phone with RFS incorporating an Image Peripheral Outline (IPO) in which the user selects an item on the MCD display and the HCS (or optionally the MCD) automatically selects a perimeter edge of the image selected to determine the extent of the RFS;

FIG. 31 illustrates a top right perspective view of a mobile phone with RFS incorporating an Image Polygon Region (IPR) in which the user defines a perimeter outline on the MCD display to determine the extent of the RFS. The HCS then processes the image contained within the selected polygon region by referencing previously transmitted RVS image data corresponding to the selected perimeter region; and

FIG. 32 illustrates a top left perspective view of a mobile phone with RFS incorporating an Image Polygon Region (IPR) in which the user defines a perimeter outline on the MCD display to determine the extent of the RFS. The HCS then processes the image contained within the selected polygon region by referencing previously transmitted RVS image data corresponding to the selected perimeter region.

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiments of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of a REAL-TIME DYNAMIC HYPERLINKING SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Remote Video Stream not Limitive

The present invention anticipates that a wide variety of remote video streaming formats may be used to implement the video streaming component of the present invention. Without limitation, the RVS may include audio and/or video formats including but not limited to: MPEG; MPEG-2; MPEG-4; H.264; THEORA; WEBM; DIRAC; REALVIDEO; VP8; and HEVC.

### Host Computer System HOS not Limitive

The present invention anticipates that a wide variety of host computer system and host operating system software (HOS) may be used to implement the present invention. Without limitation, the HOS may include MICROSOFT® WINDOWS®; MAC®; and LINUX® operating system products.

### “The Internet” Defined

The following definition for the phrase “the Internet” as used within this document is taken in part from the IBM Redbook entitled “TCP/IP Tutorial and Technical Overview” (www.ibm.com/redbooks; December 2006). The words “internetwork” and “internet” are simply a contraction of the phrase “interconnected network”. However, when written with a capital “I”, the phrase “the Internet” refers to the worldwide set of interconnected networks. Therefore, the Internet is an internet, but the reverse does not apply. The Internet is sometimes called the connected Internet. The Internet consists of the following groups of networks:
Backbones: Large networks that exist primarily to interconnect other networks. Also known as network access points (NAPs) or Internet Exchange Points (IXPs). Currently, the backbones consist of commercial entities.
Regional networks connecting, for example, universities and colleges.
Commercial networks providing access to the backbones to subscribers, and networks owned by commercial organizations for internal use that also have connections to the Internet.
Local networks, such as campus-wide university networks.

In most cases, networks are limited in size by the number of users that can belong to the network, by the maximum geographical distance that the network can span, or by the applicability of the network to certain environments. For example, an Ethernet network is inherently limited in terms of geographical size. Therefore, the ability to interconnect a large number of networks in some hierarchical and organized fashion enables the communication of any two hosts belonging to this internetwork.

### General Concept

The present invention has as a general objective to use cloud technologies to deliver the latest software solutions to any Internet enabled devices. The disclosed invention provides a complete desktop experience to mobile computing devices (MCDs) such as inexpensive pen and touch devices. Various invention embodiments, for example, would permit any WINDOWS®, MAC®, or LINUX® software application running on a host computer to effectively operate on a $50 ANDROID® tablet.

The present invention operates to lower the effective cost of deploying cloud computing solutions. The present invention leverages cloud computing to put the power of an expensive laptop into the hands of individuals unable to afford the tools necessary to support traditional cloud computing resources. The present invention allows for an individual in any underdeveloped nation with a cellphone Internet connection and inexpensive tablet computer to have the same software tools available to any person in a developed nation.

This objective is achieved by changing the way in which software is deployed to mobile devices. Rather than executing host software applications (HASs) on the mobile computing device (MCD), these applications are executed on cloud host computer systems (HCSs). The presentation displays for these HASs operating on the HCSs are then streamed as video to the MCD. This allows the HSC to perform the heavy processing associated with the HAS and simultaneously minimize the communication bandwidth necessary to support a virtualized display to the MCD. User input from the MCD is translated into native HCS user input protocols and transparently entered into the HAS.

This approach to distributing HASs on MCDs has several advantages, including:
Remote users need only support inexpensive MCD hardware to have access to powerful HASs resident on the HCS.
HAS software can be automatically updated in a central HCS rather than require deployment to a plethora of remote MCDs.
HAS software licensing can be leveraged to only support the maximum number of ACTIVE MCDs rather than licenses to all EXISTING MCDs.
Software licensing fees associated with virtual operating systems and virtualized desktops are eliminated.
The remote MCD need not have extensive hardware capability, just the capability of displaying video. All processing, memory, and storage requirements are provided by the HCS.
The user experience on the MCD directly maps that which would be experienced on a local HCS.
The processing and communications overhead associated with virtual desktops is eliminated (no 30 Hz/60 Hz refresh overhead associated with many virtualized desktops).
User files are stored on the HCS and are not lost if the MCD is damaged, lost, or stolen.
   One skilled in the art will recognize that this list is only exemplary and non-exhaustive.

### System Overview (0100)

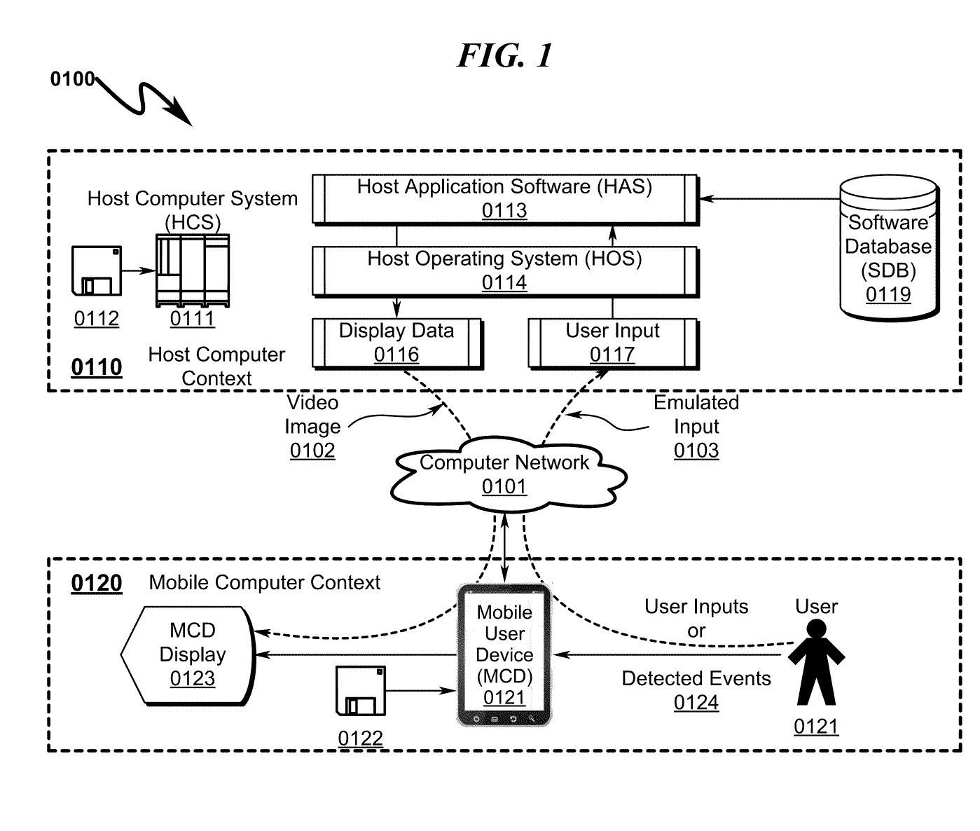

The general invention concept may be better understood by inspecting the system overview block diagram depicted in FIG. 1 (0100). In this exemplary system embodiment, a host computing context (0110) is connected with a mobile computing context (0120) via the use of a computer REAL-TIME DYNAMIC HYPERLINKING SYSTEM AND METHOD communication network (CCN) (0101). In each context (0110, 0120) there are corresponding computing devices such as a host computer system (0111) and mobile computing device (0121) each executing machine instructions read from computer readable media (0112, 0122).

Within the host computer context (0110), host application software (0113) is retrieved from a software database (SDB) (0119) and typically run under control of a host operating system (HOS) (0114) executed within the context of the host computer system (HCS) (0111). This HAS (0123) has both display (0116) and user input (0117) interfaces to the HOS (0114).

The present invention translates the display data (0116) component of the HAS (0113) output to a video stream (0102) that is communicated over the CCN (0101) to the MCD display (0123) under control of a thin client application running on the MCD (0121). The advantage of this approach to cloud computing application deployment is the ability to minimize the hardware needed on the MCD (0121) to run a software application and also minimize the CCN (0101) network bandwidth necessary to support the application remotely. By converting the display data (0116) to streaming video, the use of advanced video compression technologies can be used to reduce the necessary bandwidth to support the MCD video display (0123) of the HAS (0113) display content (0115).

The HAS (0113) user input (0117) is handled by the MCD (0121) via the use of user inputs (0124) received on the MCD (0121) and relayed via the CCN (0101) to the user input (0117) portion of the HOS (0114) running on the HCS (0111). The MCD user input (0124) is then passed through an emulator (0103) to convert MCD user input (0124) into user input information (0117) compatible with both the HOS (0114) and the HAS (0113).

Note that this approach to application deployment is also efficient with respect to software installation and maintenance in that the SDB (0119) may serve as a central repository for all software to be deployed to a plethora of remotely connected MCD (0121) systems. Additionally licensing for the software contained in the SDB (0119) may be purchased based on simultaneous use rather than on a per-MCD installation basis, thus reducing the overall cost of deploying software to MCDs that may not necessarily make simultaneous use of the software.

### Method Overview (0200)

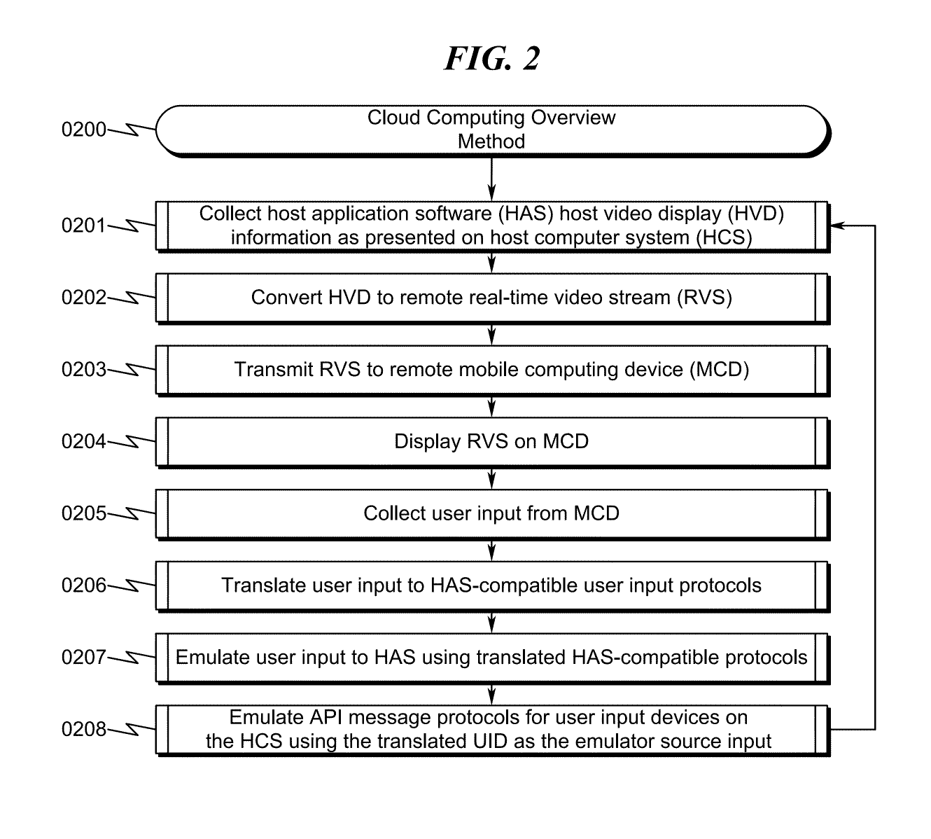

An exemplary present invention method can be generally described in the flowchart of FIG. 2 (0200) as incorporating the following steps:
(1) Collecting host application software (HAS) host video display (HVD) information as presented on host computer system (HCS) (0201);
(2) Converting the HVD data to a remote real-time video stream (RVS) (0202);
(3) Transmitting the RVS to a remote mobile computing device (MCD) over a computer communication network (CCN) (0203);
(4) Display the RVS on the MCD display screen (0204);
(5) Collecting user input from the MCD (0205);
(6) Translating the MCD user input to a HAS-compatible user input protocol (0206);
(7) Emulating the MCD user input to the HAS using translated HAS-compatible user input protocols (0207); and
(8) Emulating API message protocols for user input devices on the HCS using the translated UID as the emulator source input (0208).

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### System Detail Overview (0300)

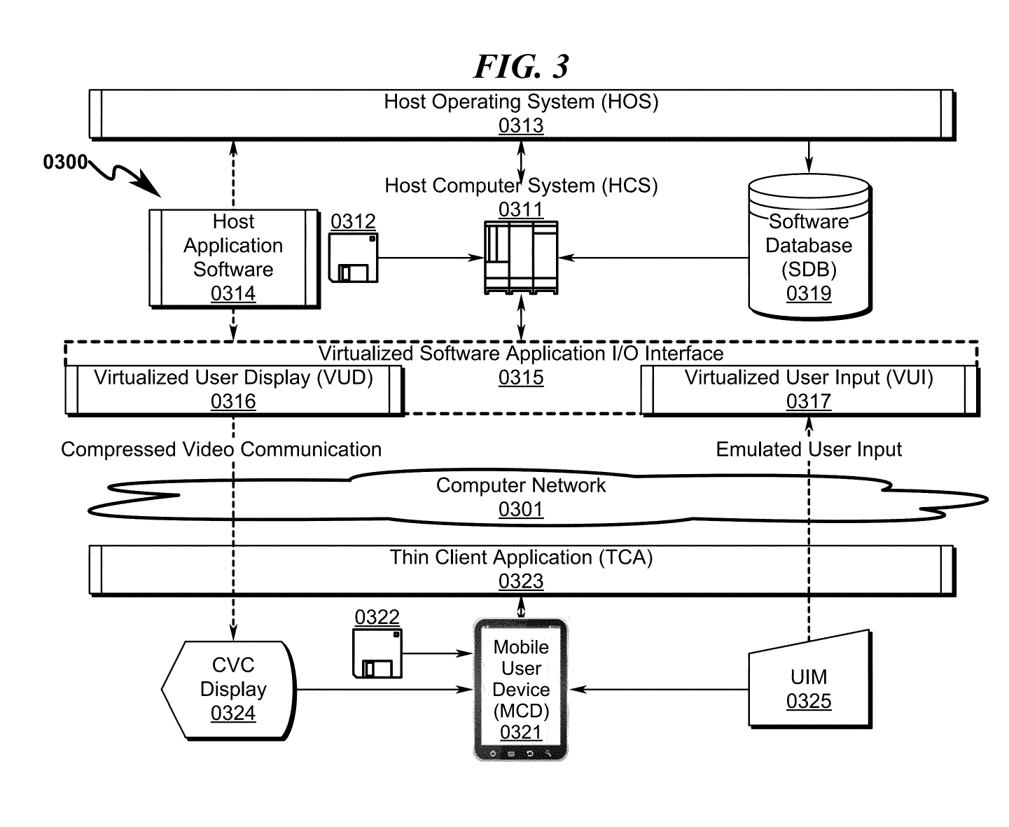

Additional detail regarding operation of a preferred invention embodiment may be found by inspecting the block diagram depicted in FIG. 3 (0300). In this exemplary system embodiment the host computer system (HCS) (0311) executing software read from a computer readable medium (0312) operates under control of a host operating system (HOS) (0313) to retrieve and execute application software (0314) from a software database (0319). This application software (0315) as it operates under control of the HOS (0313) interacts with a virtualized software application I/O interface (0315) that mimics the hardware interfaces associated with a normal display monitor and keyboard/mouse input via the use of virtualized user display (VUD) (0316) and virtualized user input (VUI) (0317) device driver modules.

The VUI device driver (0316) is responsible for converting standard GUI display commands (such as window displays, character output, graphic output, and the like) into a compressed video communication (CVC) video stream that is transmitted over a communication network (0301) to mobile user computing device (MCD) (0321) executing software read from a computer readable medium (0322) and implementing a thin client application (TCA) (0323) responsible for mimicking a HCS (0311) user experience within the context of the MCD (0321). The TCA (0323) comprises a CVC display (0324) component responsible for converting the VUD (0315) output to the display of the MCD (0321). The use of CVC communication between the HCS (0311) and MCD (0321) may in some embodiments permit standard MPEG or other video decoders to be used in this display capacity.

Integration of user input to the HAS (0314) is accomplished by use of a user input module (0325) component that operates with the TCA (0323) to collect a variety of user input (e.g., keypad entries, hand gestures, simulated mouse gestures, etc.) from the MCD (0321) and translate these to compatible user inputs for the VUI (0317) that are then translated to appropriate HOS (0313) inputs and passed to the HAS (0314) for processing by the application software.

### Method Detail Overview (0400)

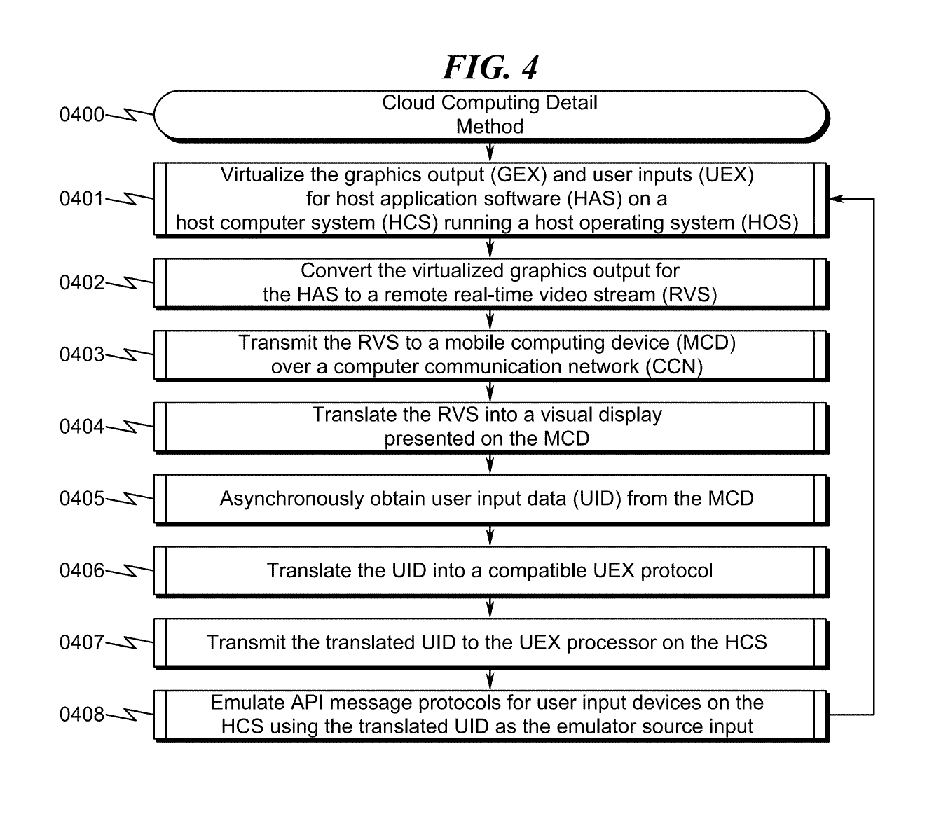

An exemplary present invention detailed method can be generally described in the flowchart of FIG. 4 (0400) as incorporating the following steps:
(1) Virtualizing the graphics output (GEX) and user inputs (UEX) for host application software (HAS) on a host computer system (HCS) running a host operating system (HOS) (0401);
(2) Converting the virtualized graphics output for the HAS to a remote real-time video stream (RVS) (0402);
(3) Transmitting the RVS to a mobile communication device (MCD) over a computer communication network (CCN) (0403);
(4) Translating the RVS into a visual display presented on the MCD (0404);
(5) Asynchronously obtaining user input data (UID) from the MCD (0405);
(6) Translating the UID into a compatible UEX protocol (0406);
(7) Transmitting the translated UID to the UEX processor on the HCS (0407); and
(8) Emulating API message protocols for user input devices on the HCS using the translated UID as the emulator source input (0408).

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### TCA Modules (0500)

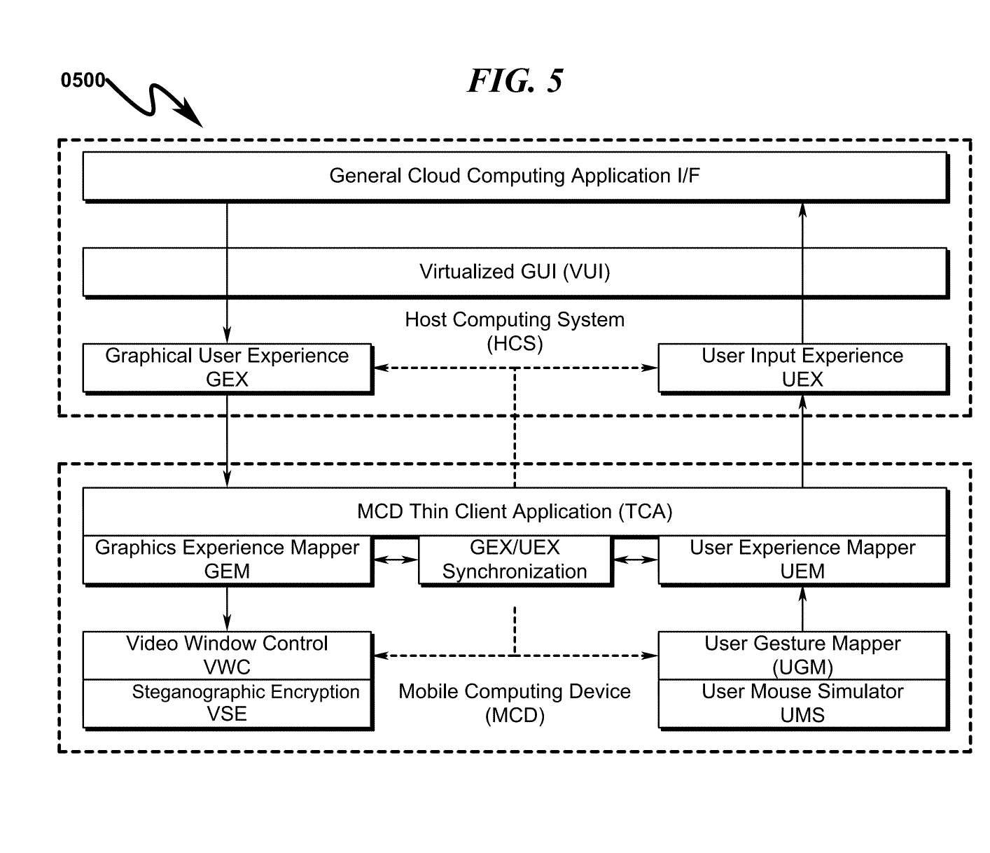

The MCD TCA may incorporate a number of subfunction modules as depicted generally in FIG. 5 (0500). These modules may include but are not limited to any of the following:
Graphics Experience Mapper (GEM). Generally responsible for receiving the video stream from the GEX component of the VUI virtualizer and presenting this visual information to the MCD display.
User Experience Mapper (UEM). Generally responsible for receiving keyboard/mouse/tablet user input entered on the MCD and translating this information into a standardized format that is interpreted by the UEX component of the VUI virtualizer.
Video Window Control (VWC). Generally responsible for setting the viewport into the virtualized video stream presented on the MCD. Since the MCD may have a smaller screen size than that supported by the HCS, the VWC permits the MCD user to zoom/pan across a wider display space to achieve a readable screen.
Steganographic Encryption (VSE). This TCA component may be used to interpret steganography information embedded within the video stream to support secure data communication between the HCS and MCD. Note that since this information is interpreted in view of the compressed video image, tapping the communication link between the HCS and MCD will be ineffective in interpreting this information.
User Gesture Mapper (UGM). This TCA component maps user gestures or other user inputs associated with the MCD to user-defined or pre-defined actions by the UEX virtualization component of the VUI. Note that this component may inspect information associated with a touch screen on the MCD but may also include captured video, captured audio, or other user inputs that are not formally associated with a keyboard and/or mouse/trackball/touchpad.
User Mouse Simulator (UMS). This TCA component simulates the functionality of a mouse/trackball/touchpad to support cursor displays and input associated with these types of devices. In many circumstances this component may comprise advanced features to minimize the communication bandwidth required by the CCN to support the HCS/MCD connection. For example, the UMS may incorporate mouse trajectory tracking to determine the arcuate trajectory of a local mouse movement and translate this to trajectory curve information that is transmitted to the UEX rather than streaming individual pixel locations to the UEX interface. This can dramatically reduce the bandwidth required by the CCN to support the remote application context of the HCS.
GEX/UEX Synchronization. This TCA component is responsible for ensuring that the GEM/UEM modules are properly synchronized with the GEX/UEX interfaces operating on the HCS. Because the CCN may operate in a variety of degraded modes, the HCS/MCD communication may become unstable or disconnected due to intermittent CCN failure. The GEX/UEX synchronization module ensures that the GEM and UEM correspond to a consistent state of the GEX/UEX VUI virtualization context.
   One skilled in the art will recognize that this list of TCA features is illustrative and not limitive of the present invention.

### Steganographic Encryption (0600)

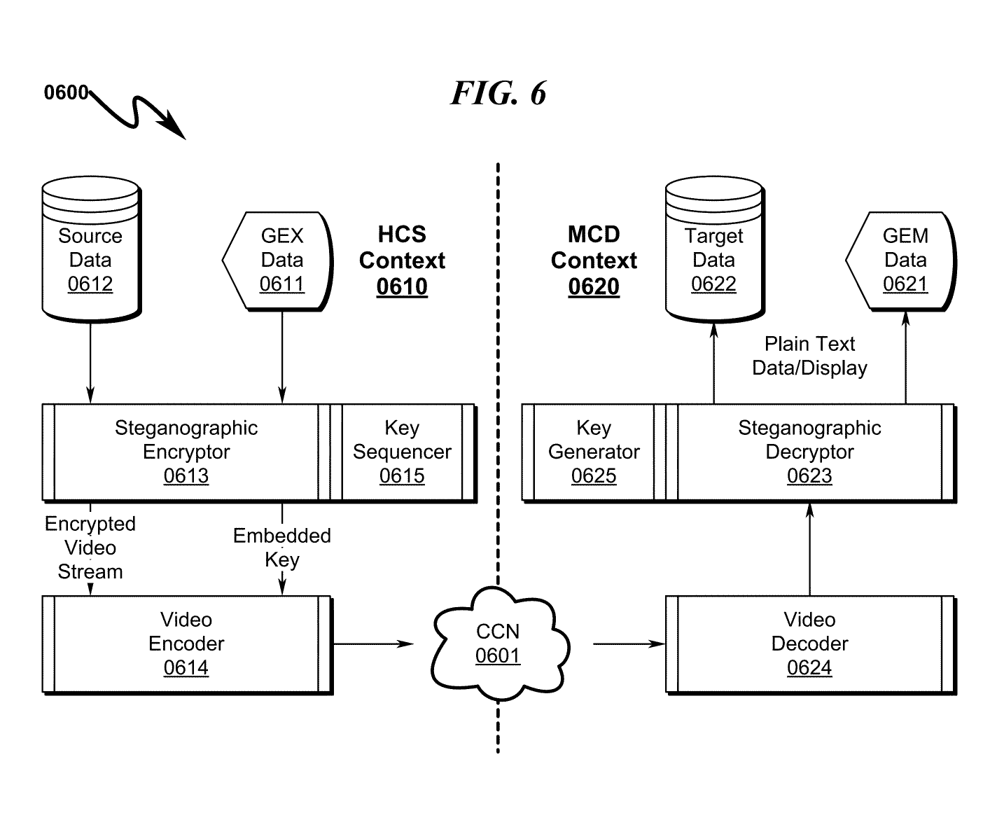

As depicted in FIG. 6 (0600), the present invention anticipates that some preferred embodiments may incorporate steganographic encryption within the video stream transmitted between the HCS and MCD. This use of steganographic encryption may form the basis for a secure web browser interface that provides an added layer of security on top of that provided by conventional web browser services.

Steganography is the art or practice of concealing a message, image, or file within another message, image, or file. The advantage of steganography over cryptography alone is that the intended secret message does not attract attention to itself as an object of scrutiny. Plainly visible encrypted messages—no matter how unbreakable—will arouse interest, and may in themselves be incriminating in countries where encryption is illegal. Thus, whereas cryptography is the practice of protecting the contents of a message alone, steganography is concerned with concealing the fact that a secret message is being sent, as well as concealing the contents of the message.

Steganography includes the concealment of information within computer files. In digital steganography, electronic communications may include steganographic coding inside of a transport layer, such as a document file, image file, program or protocol. Media files are ideal for steganographic transmission because of their large size. For example, a sender might start with an innocuous image file and adjust the color of every 100th pixel to correspond to a letter in the alphabet, a change so subtle that someone not specifically looking for it is unlikely to notice it.

The present invention anticipates the use of steganography in conjunction with encryption to permit the merging of both GEX display data (0611) and source data files (0612) within an encryption process (0613) operating in the HCS context (0610) to form a merged video data stream comprising both an encrypted video stream as well as an optional embedded key. This merged video information is then input to a video encoder (e.g., MPEG encoder) and transmitted via the CCN (0601) to a video decoder (0624) operating in the MCD context (0620). The video decoder (0624) regenerates the video stream and this video stream is then run through a steganographic decryption process (0623) that extracts the GEM display data (0621) and optional target data (0622). The fact that the video encoder (0614) and video decoder (0624) may implement lossy compression/decompression may be used in this process to hide the encryption keys associated with the data transfer and make the decryption of the combined source data and GEX display even more difficult for attacks that rely on tapping the CCN communication link.

Within this context a key generator (0625) may be populated by MCD user inputs from the UEM or GEM modules and be used to populate a key sequencer (0615) that is the basis of the original encryption process (0613). It is significant to note that this process is capable of supporting a number of secure data subchannels within the video stream and thus simultaneously support a number of GEX/GEM displays (0611, 0621) and/or source/target databases (0612, 0622).

### UEX/UEM Translation/Mapping (0700)

### Overview

The present invention anticipates that there may be a physical disconnect between the hardware provided by the MCD and that associated with the host application software (HAS). For example, the HAS may be configured to run in a personal computer (PC) environment and expect the availability of a conventional QWERTY keyboard and mouse/trackball/touchpad as standard user input devices, whereas the MCD may not support a keyboard or mouse but only a touchscreen display. The present invention permits the MCD to provide input to the HAS by means of a combination of a user experience mapper (UEM) and user input experience translator (UEX).

### Exemplary Tablet Computer Mapping

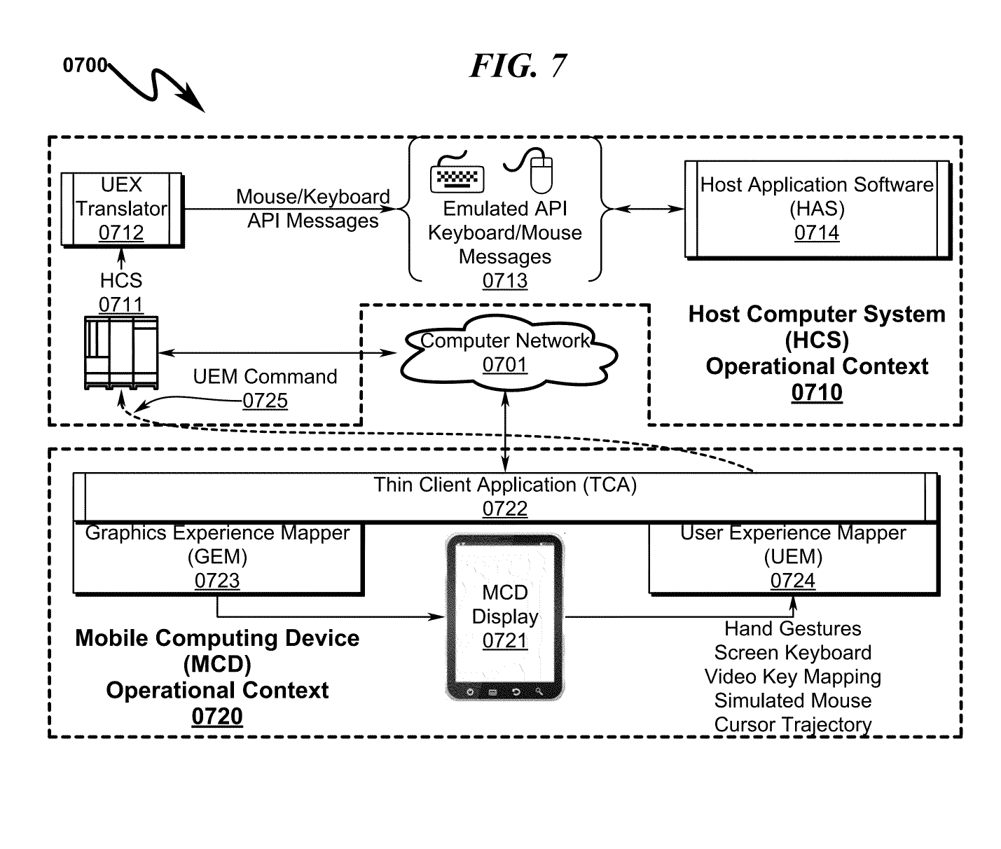

An example of this situation is depicted in FIG. 7 (0700), wherein the HCS context (0710) and MCD operational context (0720) are linked via a computer communication network (CCN) (0701). Within this context the MCD display (0721) is linked to the HCS operational context (0710) via a thin client application (TCA) (0722) that controls both a graphics experience manager (0723) responsible for presentation of information on the MCD display (0721) and a user experience mapper (0724) responsible for gathering user inputs to the MCD and presenting them properly to the HCS context (0710).

The MCD operational context (0720) and specifically the MCD display (0721) are scanned for a variety of user input function types, such as hand gestures, simulated keyboard screen inputs, screen touches corresponding to mapped regions of video, a simulated mouse input and/or movement (including mouse clicks and button activations), and cursor trajectory information. This information is packetized by the user experience mapper (UEM) (0724) in a standardized application-agnostic format and sent as a UEM command (0725) by the TCA (0722) via the CCN (0701) to the HCS (0711). The HCS (0711) relays the UEM command (0725) to the UEX translator (0712) that translates the generic UEM command (0725) into an operating system specific emulated API message (0713) that is then relayed via internal operating system message queues to the host application software (HAS) (0714).

### Exemplary Mapping Functions

While a wide variety of UEM functions are anticipated as within the scope of the present invention, several are preferred and listed below:
Hand Gestures. Hand gestures may be mapped to a variety of function keys. For example, “swiping” an application screen image may map to an “ALT-TAB” WINDOWS® keyboard message that would translate into a “display next active application window” message being processed by the HCS (0711) and associated operating system software. As depicted in this example, UEM (0724) operation may include the mapping of HAS (0714) keys that include operating system functionality.
Screen Keyboard Emulation. A keyboard (possibly including a QWERTY keyboard or some other form of simulated keyboard) may be displayed on the MCD (0721) and keys mapped to this display used as the encoding of the UEM mapping (0724) and/or UEM command (0725).
Video Key Mapping. Areas of the MCD display (0721) that are either related to or disconnected from the HAS (0714) may be identified within the UEM (0724) and trigger one or more equivalent characters to be transmitted to the HAS (0714) as an emulated API message (0713). Note that since the MCD display (0721) is mapped using a video image rather than a rasterized image as normally presented by the HAS (0714), the UEM (0724) must coordinate with the GEM (0723) to enable the translation from video to raster coordinates.
Simulated Mouse. The UEM (0724) may incorporate logic to simulate a computer mouse (including display cursor or other visual indicia) as well as key/button input and scrolling inputs normally associated with computer mouse functionality.
Cursor Trajectory. In conjunction with the mouse simulation detailed above, the UEM (0724) may incorporate “cursor trajectory” that locally simulates the movement of the mouse cursor on the display but only transmit trajectory information on the mouse movement to the UEX translator (0712) to minimize the data traffic through the CCN (0701).
   One skilled in the art will realize that this list is illustrative and does not limit the invention scope.

### Exemplary Embodiment—AMAZON® Web Services (0800)

### Background

The present invention may also be applied in the context of AMAZON® Web Services (AWS) infrastructure. AMAZON® AppStream's STX Protocol manages streaming a computer application from AMAZON® Web Services (AWS) to local client devices. It monitors network conditions and automatically adapts the video stream to provide a low latency and high-resolution experience to users. It minimizes latency while synchronizing audio and video as well as interactively capturing input from users to be sent back to the application running in AWS.

AMAZON® AppStream deploys streaming-enabled applications on an AMAZON® EC2 instance. A streaming application can be added through the AWS Management Console, where the service creates an AMAZON® Machine Image (AMI) required to host the application and makes the application available to devices running streaming clients. The service scales the application as needed within the capacity limits that have been set to meet demand.

The AMAZON® team developed an AppStream software development kit (SDK) for integrating streaming applications into AMAZON®'s Web Services. AMAZON®'s AppStream SDK simplifies the development of interactive streaming applications and client applications. The SDK provides Application Programming Interfaces (APIs) that connect devices directly to an application. It captures and encodes audio and video, streams content across the Internet in near real-time, decodes content on client devices, and returns user input to the application.

AMAZON® has built their AppStream SDK in a native C programming language. It provides C header files and libraries that provide the functionality needed to stream an application from AMAZON® AppStream as well as receive the streamed content from the server application in a client application.

The AppStream SDK currently limits software developers to using the C language for new development or forces design challenges when utilizing other programming languages such as Microsoft C# .NET or VB.NET. When designing applications that have a graphically intensive user interface like games, it is often necessary to use a low level programming language to better manage device resources and increase performance. The SDK provides methods for creating server applications and lightweight client applications that work in conjunction with one another. For an application to function properly, it is necessary to have a server application and a client application communicating where the client application interacts with the video and audio stream that is being streamed from a server application.

The AWS AppStream application provisioning methods are extremely laborious and time intensive. It requires an in-depth knowledge of cloud computing and specific knowledge of AMAZON®'s AWS platform to provision an account for streaming applications from AWS. The learning curve is very large for an average developer when committing to streaming their application using AMAZON®'s AppStream. A heavy burden lies with either IT personnel or software developers to get applications streaming on AWS utilizing a non-intuitive web interface.

One major obstacle that currently exists with the AMAZON®'s AppStream concept is the fact that there is no built-in automation for provisioning a single or multiple applications to the AWS cloud. A second major obstacle with AMAZON® AppStream is that there are no Integrated Development Environment templates or plug-ins to assist a developer with rapid application development. A third major obstacle revolves around the requirement for the use of Java wrappers within the SDK when connecting to an entitlement service. A template for other programming languages currently does not exist within the AMAZON® AppStream SDK that provides connectivity the REST API of the AMAZON® AppStream service.

### Present Invention Solution

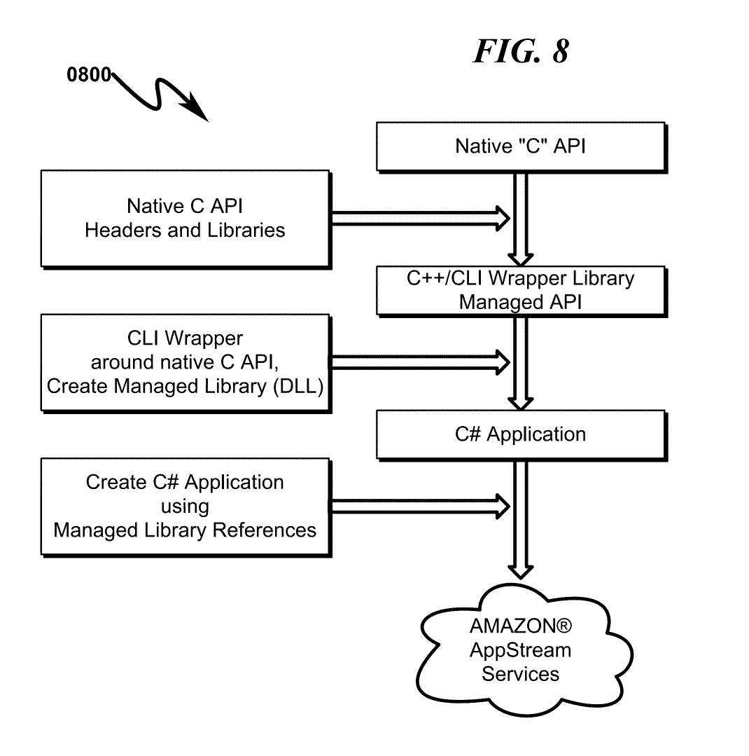

To bridge the gap between AMAZON®'s AppStream native C API's and the .NET Framework for application development, the present invention in some preferred embodiments as depicted in FIG. 8 (0800) builds a wrapper that provides interface access to AppStream API resources from within another programming language such as C# or VB. The wrapper includes interfaces from the native C environment to a Microsoft .NET managed environment using a C++/CLI wrapping technique creating a managed dynamically linked library that may be used as a reference from within a C# application. In addition to the C++/CLI library, a visual studio plug-in is designed and developed to provide .NET desktop application developers a set of tools, templates and a framework to automate the building of a streaming application using the Microsoft .NET Framework. This will increase productivity and reduce the amount of time in a development lifecycle.

To bridge the gap between AppStream application development and provisioning an AppStream application in the AWS cloud, automation is implemented in this invention embodiment. Automation is implemented using web service connections to the AMAZON® Web Services platform from within a control application that shares information within an integrated development environment.

AMAZON®'s AppStream application provisioning currently requires that an application use a single executable (.exe) file that does not require user interaction that is installed on an AMAZON® EC2 instance in silent or unattended mode. Part of the automation may occur within the setup routines that allow information to be shared with the auto provisioning application that will allow a developer to design a streaming application, create an appropriate installer, and build the provisioning connections.

AMAZON® AppStream application provisioning currently requires a software developer to build an entitlement service for authentication. An entitlement service authenticates and authorizes users between a light weight client and an AppStream server application, ensuring that only those clients entitled to access the application do so. The entitlement service can authenticate users in a variety of ways:
by comparing user login credentials to a list of subscribers in a database,
by using an external login service, or
by authenticating all clients.
   The current AppStream SDK only contains Java wrappers for the (Representational State Transfer) REST API of the AMAZON® AppStream service. The wrapper classes handle the overhead of signing requests to the REST API and provide functions that an entitlement service can call in order to create new client sessions.

To bridge the gap between the AppStream application and authentication, an entitlement service is automated within an Integrated Development Environment such that it will expose a template that can be utilized with an AppStream application. The entitlement service sends HTTP requests directly to the AMAZON® AppStream REST API using a .NET Framework programming language.

### Exemplary N-Multicore CPU Embodiment (0900)-(1200)

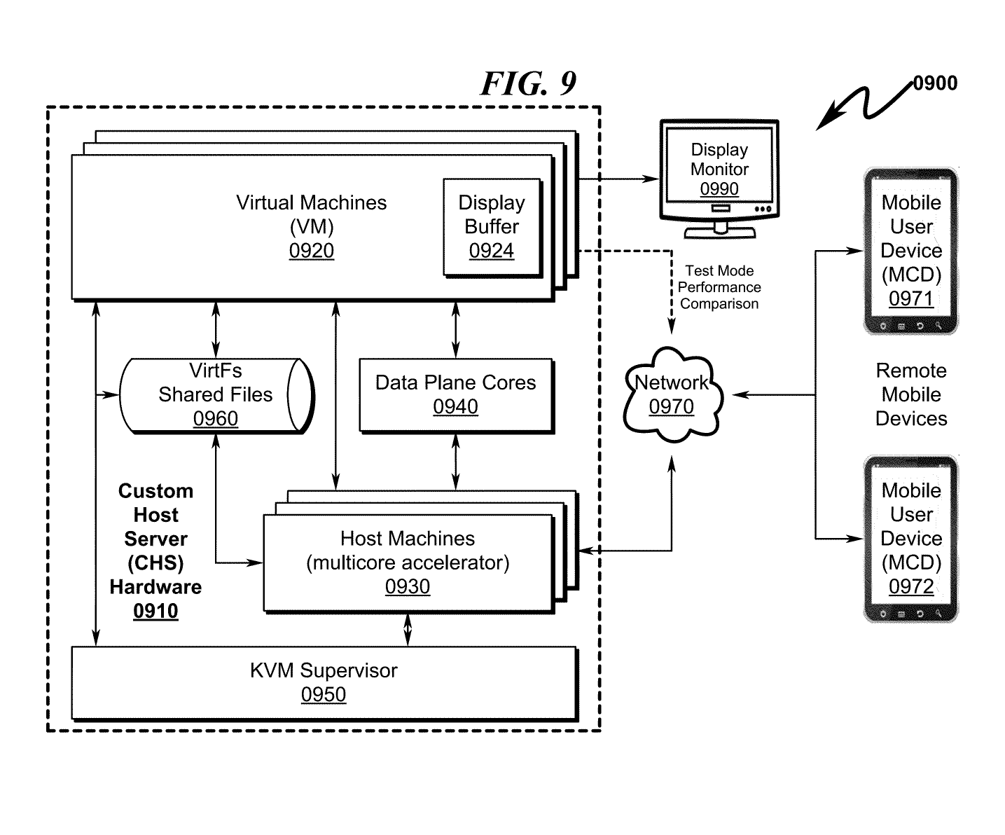

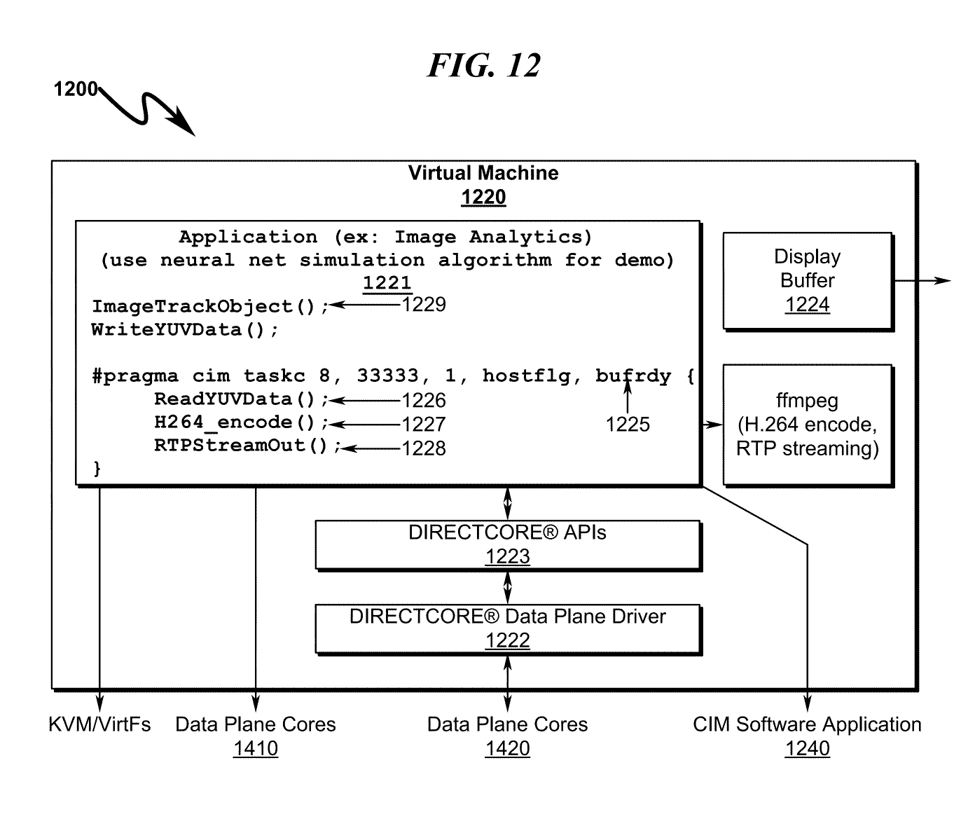

An exemplary N-multicore CPU embodiment of the present invention is depicted in FIG. 9 (0900)-FIG. 12 (1200) and will now be discussed in more detail.

### Server Cores and Data Plane Cores not Limitive

The present invention anticipates a wide variety of server CPU cores and Data Plane cores may be used in this disclosed embodiment, including x86 (Intel) and ARM.

### Multicore Accelerator Cores not Limitive

The present invention anticipates a wide variety of multicore accelerator cores, including compute intensive, GPU (Graphics Processing Unit) neural network, packet processing, and other types, may be used in this disclosed embodiment. Examples of manufacturers of these cores include Intel, Texas Instruments, Nvidia, Freescale, ARM, and others.

### GENERAL CONCEPTS, DEFINITIONS, AND ADVANTAGES

This present invention embodiment combines customized hardware (in the form of suitable low SWaP multicore accelerator expansion cards) that are configured into customized compute servers, including:
host operating system (such as Linux);
hypervisor (such as KVM, or Kernel based Virtual Machine);
data plane cores; and
a plurality of Virtual Machines (VMs) that run user applications.

Definitions relating to this exemplary embodiment that will be understood by those skilled in the art include:
Data Plane Cores. Data plane cores run minimal software, without a fully formed operating system, providing a low-level, very fast interface to motherboard hardware components in the server such as PCIe and network I/O.
Virtualization. Virtualization is the process of allowing multiple “virtual machines” (VMs) to run on one physical machine, sharing physical resources such as hard disk drive and other storage, network input/output, screen display (monitor), keyboard, mouse, etc., with each VM theoretically being unaware of other VMs. However, due to performance penalties imposed by the process of virtualization and resource sharing, VM users may surmise they are being affected by other users.
Heterogeneous cores. The term “heterogeneous cores” refers to a variable mix of core types used together inside the HPC server. Such cores are fundamentally different (i) at the chip (semiconductor) architecture level, and (ii) at the machine instruction code level (represented to the programmers by the chip's “native” assembly language). These fundamental differences in chips (and thus all cores contained on a chip) result in substantial differences in tool chains and utilities to build executable programs (starting from source code created by the programmer). In some cases, the programming model for heterogeneous cores may also differ substantially.
Guest. Guest is synonymous with a Virtual Machine (VM). This terminology arises from use of “host” and “guest”, where host means the physical machine and its operating system running on the server.
SWaP. SwAP means size, weight, and power consumption, and is typically used in the context of constraints, or limitations under which servers in the cloud computing or data center must operate.
Pragma. A pragma is an element of source code that is “outside the scope” of the native programming language. Typically pragmas are used to mark “begin” and “end” of source code sections and apply a desired action or attribute to the designated source code section. The pragmas used by the present invention are pre-processed by CIM software, and ignored by native compilers.
KVM. KVM means Kernel based Virtual Machine hypervisor that supervises the virtual machines installed on the custom computer server. The KVM hypervisor runs on the physical machine and is aware of all server resource and component usage, at all levels, and at all times. Note that in the case of Data Plane cores and Accelerator cores, the KVM hypervisor is typically aware of the presence and “amount”, or extent of these resources, but not of internal operation inside these resources.
API. API means Application Programming Interface, and typically refers to a series of function (or procedure) calls made available, or “exposed”, to programmers by a software module such as a library, driver, or other software component.

The present invention exemplary embodiment has an approach to HPC and supercomputing in cloud computing and data centers that provides several advantages, including:
Provides substantial performance increase for virtualized servers and avoids performance penalties associated with virtualization, a process that optimizes usage of servers (allocation between users), and has become prevalent in cloud computing and data centers to reduce equipment and operating costs. Performance increases are realized for both compute intensive processing and reduce latency with increased bandwidth network input/output.
Accelerates a wide range of user software running inside Virtual machines (VMs) that host a range of operating systems (such as Linux, WINDOWS®, etc.).
Provides a simplified, easy-to-use programming interface.
Provides a uniform, consistent method of incorporating and programming a range of heterogeneous CPU cores into standard, off-the-shelf servers.
Reduces hardware costs and software licensing costs and usage fees compared to expensive, dedicated supercomputing systems.
Remote devices need not have extensive computational and network input/output resources in order to run complex, highly compute intensive applications (such as face, voice, and location recognition) and personal computational finance applications.
   One skilled in the art will recognize that the above list of advantages is only exemplary and non-exhaustive.

### Ancillary Embodiment Description (0900)

Additional detail regarding operation of a preferred invention embodiment may be found by considering a video stream data flow in FIG. 9 (0900). In this exemplary system embodiment a custom computing server enhanced for HPC and Supercomputing applications (0910) hosts a plurality of VMs (0920), each running independent user applications with dedicated user display buffers (0924) (i.e. one display per user). The HPC server (0910), enhanced with a plurality of multicore accelerators (0930), and performing Background Acceleration as described herein, captures each VM display buffer video output (0924), encodes and compresses the display video content for efficient network transmission, and streams the compressed output to remote devices, allowing each VM user to view, control, and otherwise run their applications remotely. From a server efficiency perspective, the ability to host multiple users concurrently demonstrates the performance benefit of this invention embodiment.

In another preferred invention embodiment, additional detail may be found by considering a modification of the video stream data flow in FIG. 9 (0900). In this case video input streams are received from a plurality of remote devices (0971, 0972), and processed by one or more VMs (0920) executing image analytics and image processing algorithm programs, which are accelerated on the multicore accelerator (0930). Results such as face recognition or location recognition are then streamed back to remote device users. This invention embodiment demonstrates a great benefit to users of mobile devices, which lack sufficient computational resources and power sources to perform complex algorithms and processing required by artificial intelligence applications or image analytics.

### System Description Detail (1000)-(1200)

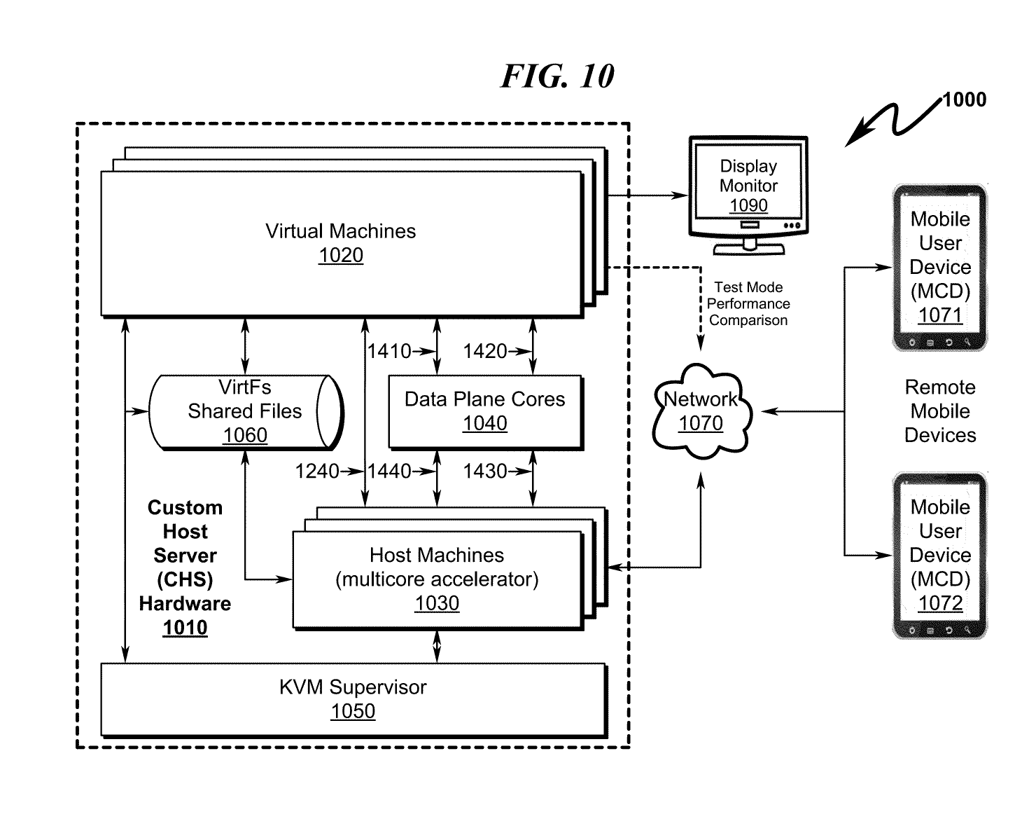

The general invention concept may be better understood by inspecting the system overview block diagram depicted in FIG. 10 (1000). In this exemplary system embodiment, a custom host server (CHS) (1010) contains a plurality of virtual machines (VMs) (1020), a host Linux machine (1030), a plurality of data plane cores (1040), a KVM (Kernel based Virtual Machine) hypervisor (1050), and a VM-host shared file system (1060).

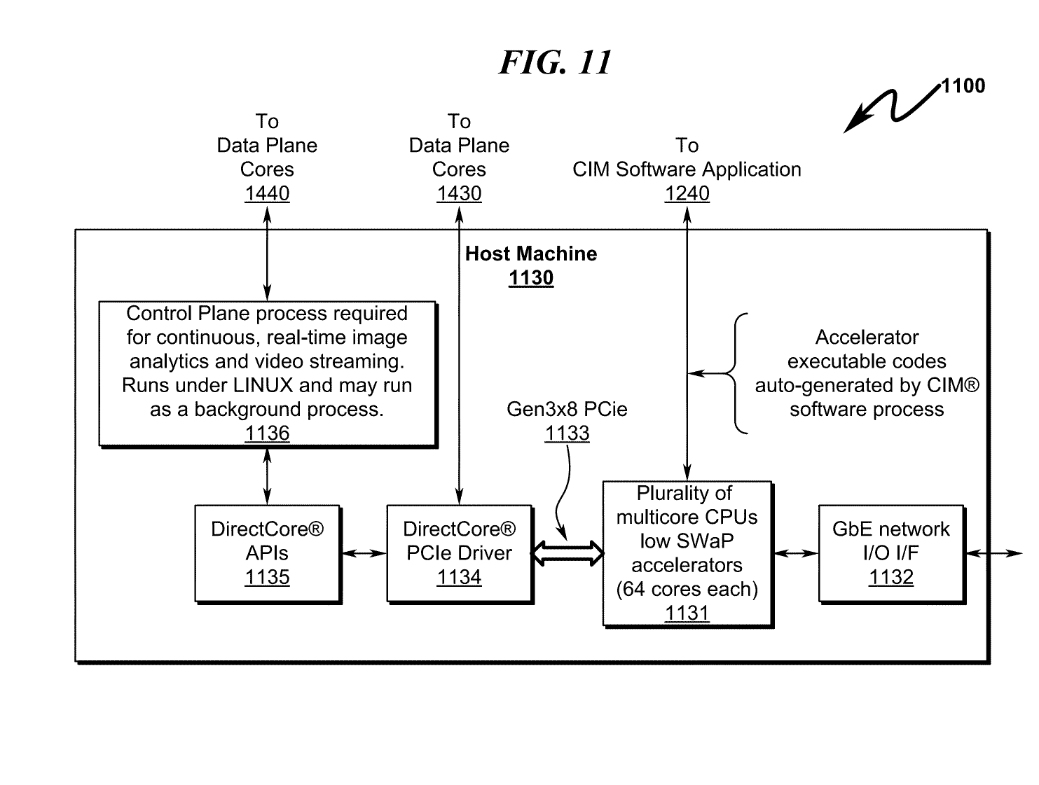

The host machines (1030) depicted in FIG. 10 (1000) are described in further detail in FIG. 11 (1100) and contain a plurality of multicore CPU accelerators (1131) connected via gigabit Ethernet (1132) and PCIE bus (1133), a DIRECTCORE® driver (1134), DIRECTCORE® API library (1135), and a control plane process (1136).

The virtual machines (1020) as depicted in FIG. 10 (1000) are further detailed in FIG. 12 (1200) and contain one or more applications (1221) such as the image analytics example (1221) shown in FIG. 12 (1200), and a DIRECTCORE® driver (1222) and DIRECTCORE® API library (1223).

The present invention allows numerous performance benefits to Virtual Machines (VMs) (1220), stemming from hardware enhancement of the custom server hardware using multicore accelerators (1131). The present invention provides two (2) types of acceleration for the VMs: (i) automated “VM Background Acceleration”, for example capture and streaming of VM screen (display) video output to remote devices, and (ii) “VM Foreground Acceleration”, by offloading specific program sections, expressed at the source code level such as (1225) and containing compute intensive functions (1226 thru 1229), to the multicore accelerator (1131).

VM Background Acceleration is accomplished by the following sequence:
The Control Plane process (1136) directly issues (1440) commands and instructions to Data Plane cores (“Data Plane commands”). Data Plane commands include (i) which VMs to operate on and which multicore accelerator (1131) cores to associate with each VM, (ii) what type of operations to perform, and (iii) memory addresses to use for both VM memory areas and multicore accelerator memory areas. In coordination with the Data Plane commands it issues, the Control Plane process (1136) also issues commands and instructions (“Control Plane commands” (1430) to the multicore accelerator (1131), using DIRECTCORE® API calls (1135) and the DIRECTCORE® PCIe Driver (1134). Control Plane commands issued to the multicore accelerator (1131) include (i) parameters for compute-intensive programming and high performance, low latency network input/output, (ii) rate and timing information required for real-time operation, and (iii) information about remote device and computer endpoints (such as their network address).
Data Plane cores (1040), running non-Linux, low-level software and guided by commands issued by the Control Plane process (1136), directly read (1410) data from memory areas of a plurality of VMs, such data including but not limited to screen (display) output, data base storage, and data analytics results.
Data Plane cores, using the DIRECTCORE® PCIe Driver (1135), transfer VM data to the multicore accelerator (1131) for compute intensive processing and network communication (1132).
The multicore accelerator (1131) performs compute intensive processing and high performance, low-latency network input/output (1132) to provide performance benefits to a plurality of VMs. The multicore accelerator (i) follows commands and instructions provided by the Control Plane process (1136) to dynamically allocate a varying number of cores to each VM, (ii) runs pre-defined executable programs, according to commands issued by the Control Plane process, in order to perform compute intensive processing on a plurality of CPU cores using a self-contained real-time operating system, memory shared between cores, memory specific to each core, and large amounts of external memory available to each CPU, and (iii) uses its self-contained network interface (1132), to transfer data to/from remote devices and other computers addressable through the public network (1070).

VM Foreground Acceleration occurs when a VM runs a program that has been annotated by the programmer to target certain sections of the program for acceleration, and is accomplished by the following sequence [ref VM Foreground Acceleration flowchart]:
A programmer uses CIM® pragmas (1225) to annotate source code sections of the program for acceleration. Source code within pragmas typically includes, but is not limited to, compute intensive processing and network I/O communication.
The CIM software process (1240) automatically parses and interprets programmer-inserted pragmas and generates independent source code streams for program sections that should continue to run on the VM and sections that should run outside the VM on the multicore accelerator (1131), thus enjoying a performance benefit and avoiding performance penalties incurred by the VM, as noted above The CIM software process augments the generated source code streams with required DIRECTCORE® API calls for data transfer, shared memory, synchronization between program sections, and load, initialization, and execution of all program sections at run-time.
The CIM software process (1240) automatically “builds” (compiles, assembles, and links) executables for the VM and for the multicore accelerator (1131).
At run-time, VM executable programs use DIRECTCORE® API calls to transfer data and commands through the DIRECTCORE® Data Plane Driver (1222), Data Plane cores (1040), and DIRECTCORE® PCIe Driver (1134), in order to communicate and synchronize with multicore accelerator (1131) program sections as needed.
The multicore accelerator (1131) performs compute intensive processing and high performance, low-latency network I/O (1132) to provide performance benefits to a plurality of VMs. The multicore accelerator (i) follows commands and instructions issued by the Control Plane process (1136) to dynamically allocate a varying number of cores to each VM, (ii) runs pre-defined and previously built executable programs to perform compute intensive processing on a plurality of CPU cores using a self-contained real-time operating system, memory shared between cores, memory specific to each core, and large amounts of external memory available to each CPU, and (iii) uses its self-contained network interface (1132), to transfer data to/from remote devices and other computers addressable through the public network (1070).
In addition to communication between VMs (1020) and the multicore accelerator (1131), the Control Plane process (1136) may also issue commands and instructions to the multicore accelerator (1131) during run-time operation, using DIRECTCORE® API calls (1135) and the DIRECTCORE® PCIe Driver (1134). Control Plane commands issued to the multicore accelerator (1131) include, but are not limited to, (i) parameters for compute-intensive programming and high performance, low latency network input/output (1132), (ii) rate and timing information required for real-time operation, and (iii) information about remote device and computer endpoints (such as their network address). This information may be in addition to information communicated between VM executable programs and the multicore accelerator (1131).

For both Background Acceleration and Foreground Acceleration, the Control Plane process (1136) continuously monitors and gathers statistics about multicore accelerator (1131) core usage, network I/O usage, and memory usage, in order to efficiently determine VM-to-core mapping (cores on the multicore accelerator), optimize performance, and prevent “overbooking” situations when multiple VMs are accelerated.

Examples of Control Plane command applications include:
Signaling for telecom applications, sometimes referred to as “session setup” and “session tear-down” (for voice/speech/voice-over-IP applications, this is typically referred to as “call setup” and “call tear-down”).
Command and control for distributed data analytics applications, for instance applying the Hadoop algorithm to allow multicore accelerator (1131) CPUs to operate as independent Hadoop processing nodes.
Command control for remote desktop video streaming, for instance level of compression, latency, video quality, and other parameters affecting the remote user experience.

In a nominal off-the-shelf commodity server, with size of “1U” (about 1.8 inches height, 19-inch width, and 30-inch depth), up to eight (8) 64-core multicore accelerators (1131) can be installed, which would provide 512 compute intensive cores. This is in addition to a number of native cores allocated to the custom server host machine (1030) and virtual machines (1020). This configuration contrasts to a typical off-the-shelf server might contain from eight (8) to thirty-two (32) native cores, all of the same type, such as Intel x86 cores or ARM cores, in which an additional 512 compute intensive cores represents a substantial increase in cores. For off-the-shelf servers with sizes of “2U”, “3U”, “5U”, etc., even more multicore accelerators may be added, resulting in servers with more thousands of cores.

Multicore accelerators (1131) in the form of PCIe expansion cards may be configured to “drop in” to the PCIe expansion slots available in properly configured server backplanes. Various such cards may be configured using this design approach, containing compute intensive and other types of cores made by semiconductor manufacturers such as Intel, Nvidia, Texas Instruments, Octasic, Freescale, and others. It is desirable for the multicore accelerator to be of “single slot thickness” to economize on space usage, and operate without excessive power consumption, in order to avoid generating excessive heat which may affect the server manufacturer's warranty and mean-time-between-failure specifications.

Note that this approach to application virtualization in deployment is also efficient with respect to software installation and maintenance in that the HPC server (1010) acts as a central repository for all software to be deployed and run by remote mobile device users. Additionally licensing cost or usage fees for the software contained in the HPC server (1010) may be calculated based on number of simultaneous users rather than on a per server basis.

### Real-Time Dynamic Hyperlinking (1300)

### Conceptual Overview

The present invention may incorporate a real-time dynamic hyperlinking functionality in which the RVS as displayed on the MCD may interact with the TCA such that a MCD user may select a portion of a RVS frame in real-time. A MCD thin client application (TCA) receives the RVS and presents this GEX content on the MCD display using a graphics experience mapper (GEM). A TCA user experience mapper (UEM) translates MCD user inputs to a form suitable for UEX protocols and communicates this user input over the CCN to the HCS for translation by the UEX into HCS operating system protocols compatible with the HAS.

Within this UEM, a RVS frame scope (RFS) of real-time user-selected RVS frame regions (comprising a FrameID (FID) and region selection information (RSI)) may be dynamically transmitted by the TCA to the HCS which then translates the associated RFS into a hyperlink associated with known and/or searched images that are matched to the RFS. Once matched, the hyperlink may be activated to trigger ancillary displays such as pop-up windows on the MCD via interaction with the HOS and/or HAS. Thus, the present invention permits content from the HCS to be streamed to the MCD with the TCA allowing selection of regions in the RVS that will then trigger additional software/popup activity on the MCD based on matching functions executed on the HCS.

### System Overview (1300)

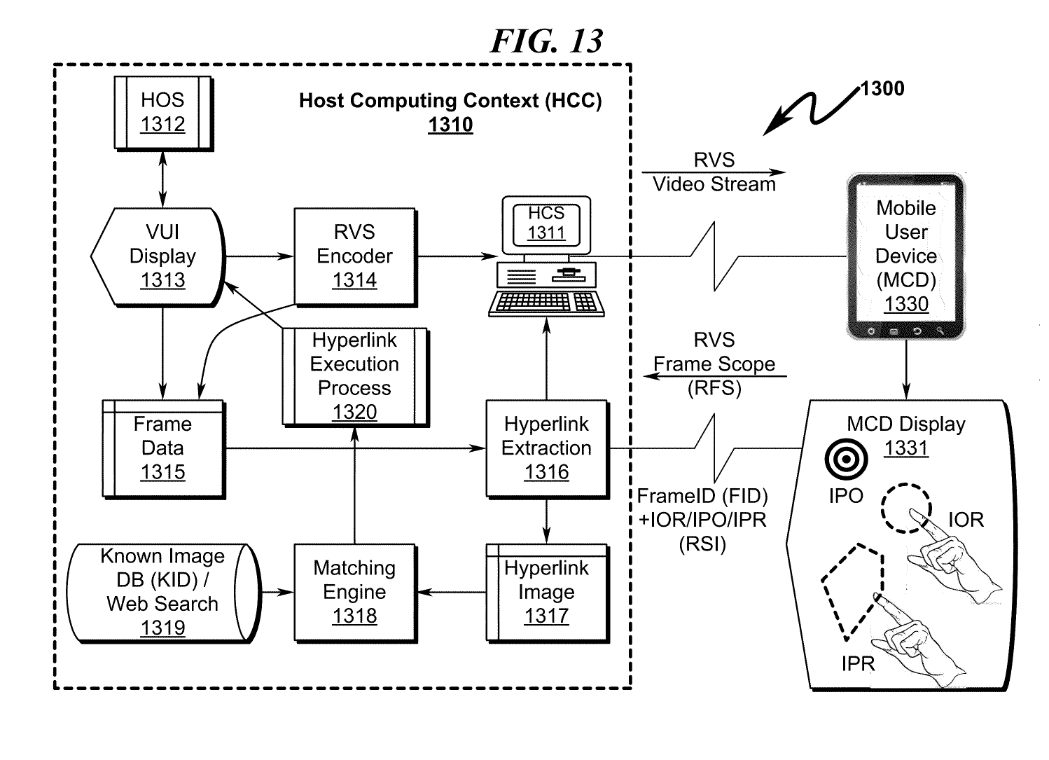

A block diagram of an exemplary invention system embodiment is generally depicted in FIG. 13 (1300). Here a host computing context (1310) communicates with a mobile computing device (MCD) (1330) using a RVS video stream as the information transport mechanism. Within this HCC (1310), a host computing system (HCS) (1311) executes a host operating system (1312) that incorporates a virtual user interface (VUI) display (1313) and hardware RVS encoder (1314) that transforms the VUI display (1313) information into a compressed video stream that is transmitted to the MCD (1330). The VUI display (1313) and/or RVS encoder (1314) provides for storage of recent/current frame data (1315) as video data is streamed to the MCD (1330).

The MCD (1330) display (1331) under control of a thin client application (TCA) operating under control of the MCD (1330) may accept a variety of RVS frame scope (RFS) information from user gestures or other user input to the MCD display (1331). Typical of this user input includes the following:
Image Origin Reference (IOR) in which the user selects a coordinate on the MCD display (1331) that is associated with some radial distance that is processed by the HCS (1310);
Image Elliptical Region (IER) in which the user selects a coordinate on the MCD display (1331) that is associated with some elliptical region that is processed by the HCS (1310);
Image Peripheral Outline (IPO) in which the user selects an item on the MCD display (1331) and the HCS automatically determines the peripheral outline of the image to be processed by the HCS (1310);
Image Polygon Region (IPR) in which the user defines an outline of a polygon that is to be processed by the HCS (1310); and
Image Binary Region (IBR) in which the user defines a selected region of the MCD display (1331) that incorporates full binary data.

Each of these types of user inputs results in a fractional portion of the image on the MCD display (1331) being identified in a shorthand form that includes a FrameID associated with the current video frame being displayed as well as some information on the selected portion of the currently displayed frame that is to be hyperlink processed by the HCS (1310). While it is possible that the MCD (1330) may transmit a portion of the displayed image back to the HCS (1310) for processing, the most efficient approach used by many invention embodiments is to reduce this information to a FrameID coupled with boundary information on the portion of the display image that must be dynamically hyperlinked by the HCS in real-time.

### Method Summary (1400)

The above-described hardware may be used in conjunction with a method for real-time dynamic hyperlinking that comprises the following steps:
(1) With a host computer system (HCS), convert a virtual video display to a remote video stream (RVS) comprising a video frame ID (FID) and video frame data (VFD) (1401);
(2) With the HCS, stream the RVS video content from the HCS to a mobile computing device (MCD) running a thin client application (TCA) (1402);
(3) With the TCA, translate the RVS into a real-time visual display presented on the MCD (1403);
(4) With the TCA on the MCD, allow a user to specify region selection information (RSI) of within a RVS frame within the RVS stream (1404);
(5) With the TCA, transmit combined FrameID and region selection information (RSI) as a region frame scope (RFS) to the HCS (1405);
(6) With the HCS, extract a search image (SIM) from previously transmitted RVS data using the RFS (1406);
(7) Compare the search image (SIM) against a known image database (KID) or against Internet search images (ISI) to determine a hyperlink match (1407); and
(8) Trigger an image associated hyperlink (IAH) based on results of SIM/KID+ISI search and insert the IAH referenced content within current RVS transmitted to the MCD (1408).

This general method summary may be augmented by the various elements described herein to produce a wide variety of invention embodiments consistent with this overall design description. This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### Exemplary Application Context

An exemplary application context for this functionality might be in dynamically hyperlinking in real-time a video stream to the MCD. For example, if the TCA is currently displaying a movie video stream, a user-selection of a product displayed in the video (for example, a pair of shoes) would result in the RVS video frame number and extent of a selection area (centered on the shoes as displayed or set by a bounding polygon surrounding the shoes) would be transmitted by the TCA back to the HCS. The HCS would then identify the selected frame and shoes using the bounding polygon. This image would then be compared to a database of known images or optionally searched on the Internet for potential matches. The results of these matches would then be hyperlinked as a popup window to the end-user on the MCD for possible purchase or other selection.

Thus, an end-user need only identify a potential item visually from a real-time RVS video stream and subsequent to this the identification of the item would be determined by a search using the HCS. The advantage to this real-time dynamic hyperlinking approach is that all intensive compute functions are executed remotely using the HCS mainframe, and the MCD is only responsible for identifying the RVS video frame number and some form of image origin reference (IOR), image peripheral outline (IPO), image polygonal region (IPR), or other region identification data associated with the item to be dynamically hyperlinked.

Within this dynamic hyperlinking system and method a vendor-supplied database (VSD) may be supplied to act as a prioritized hyperlinking manager. This VSD would, for example, provide for promotion of some product vendors over others. In this example, a promotion of one shoe vendor over another might be possible, as in sorting one shoe vendor as a possible match for the selected RVS frame segment above another shoe vendor that might match the RVS frame segment.

### HCS-to-MCD Data Flow (1500)

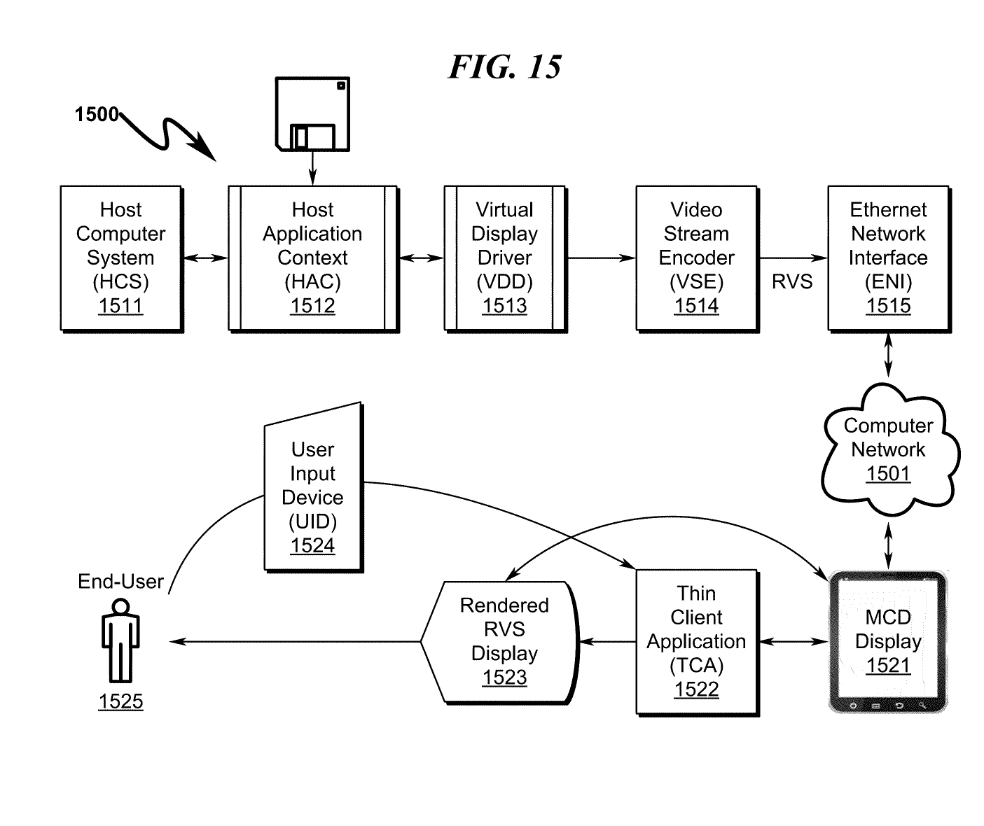

Exemplary data flow from the HCS to the MCD is depicted in FIG. 15 (1500) wherein the host computer system (HCS) (1511) executes a host application context (HAC) (1512) comprising software read from computer readable storage. The HAC (1512) interacts with a virtual video display driver (VDD) (1513) that mimics a traditional video display context but instead of displaying data on a display interacts with a video stream encoder (VSE) (1514) to convert the virtual display content to a remote video stream (RVS) that is transmitted via an Ethernet network interface (ENI) (1515) over a computer network (1501) to a remote computing device (MCD) (1521).

The MCD (1521) executes a thin client application (1522) that converts the RVS to a rendered RVS display (1523). A user input device (UID) (1524) interacts with an end-user (1525) to select portions of the RVS presented on the display (1523). These selected portions are subsequently used by the HCS to activate a real-time dynamic hyperlink as described below.

### MCD-to-HCS Data Flow (1600)

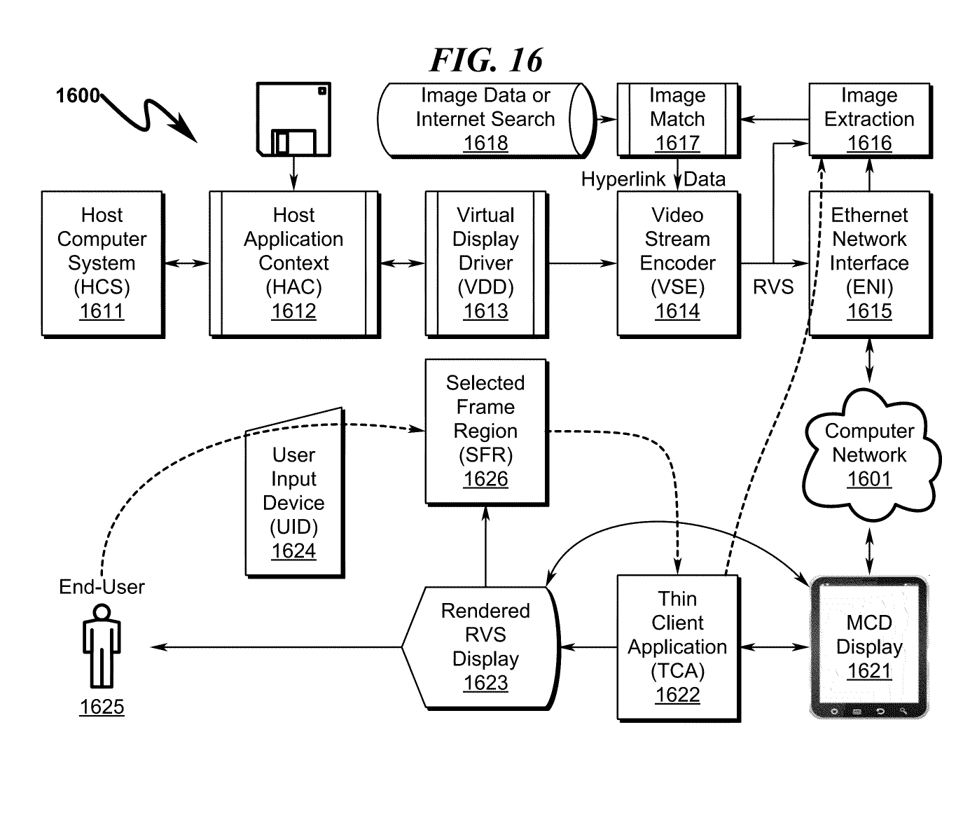

Exemplary data flow from the MCD to the HCS is depicted in FIG. 16 (1600) wherein the end-user (1625) interacts with a user input device (1624) on the MCD (1621) to identify a selected frame region (1626) on the rendered RVS display (1623). This identified region is then processed by the TCA (1622) to incorporate identifying information such as the FrameID and/or region selection information and sent to an image extractor (1616) that generates a selected image (SIM) associated with the FrameID and/or region selection information as indexed by historical RVS data. This SIM is then matched (1617) against image data (1618) that may be derived from a number of predefined databases or dynamically searched on the Internet. The result of this image matching results in a dynamic hyperlink that is then injected into the VSE (1614) and transmitted as a new RVS to the MCD (1621).

Thus, with this configuration, images or parts of images that are displayed to the MCD within the RVS may be dynamically identified in real-time and then hyperlinked to known web pages or other content that is searched on the Internet. This would, for example, provide for a scenario in which items “touched” on the MCD display could be searched for possible purchase on the Internet in real-time as they are displayed on the MCD display. Vendors may provide for prioritized purchase displays by providing image data (1618) that includes vendor-specific links to merchandise goods or service purchases. Since the image-to-hyperlink mapping may occur dynamically in real-time, these activated hyperlinks need not be statically encoded within the RVS, but may be dynamically searched at the point of entry by the end-user (1625) on the user input device (1624). In some preferred embodiments the resulting hyperlink may be used as the input to a web browser to display popup windows or windows that overlay the RVS content presented to the MCD.

### Dynamic Hyperlinking Example (1700)-(2400)

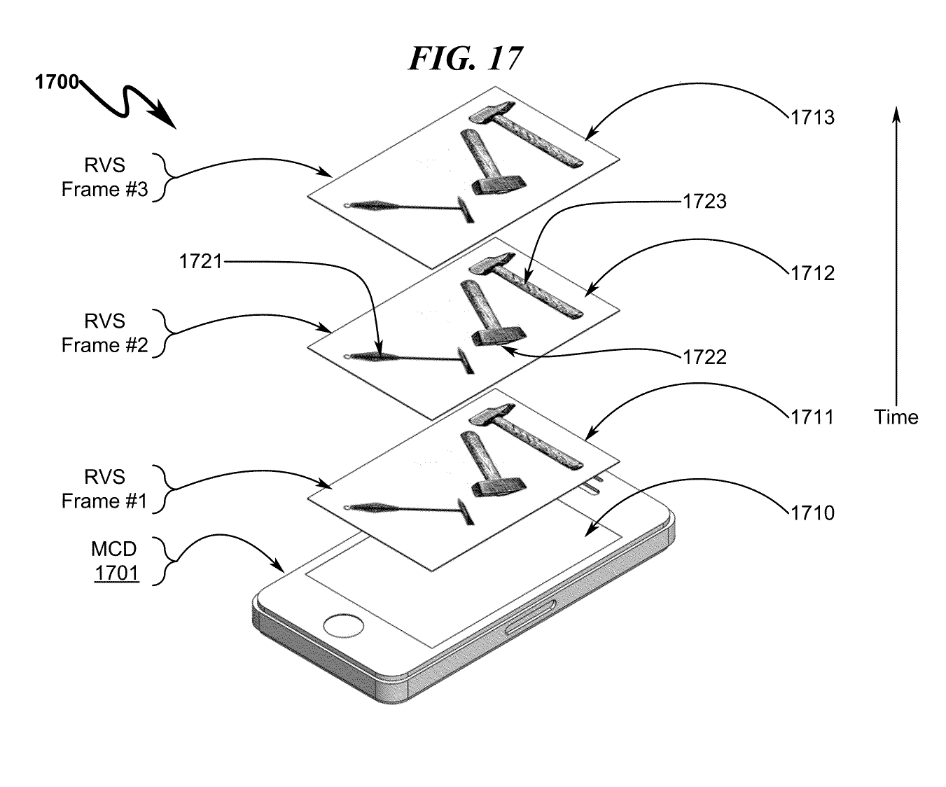

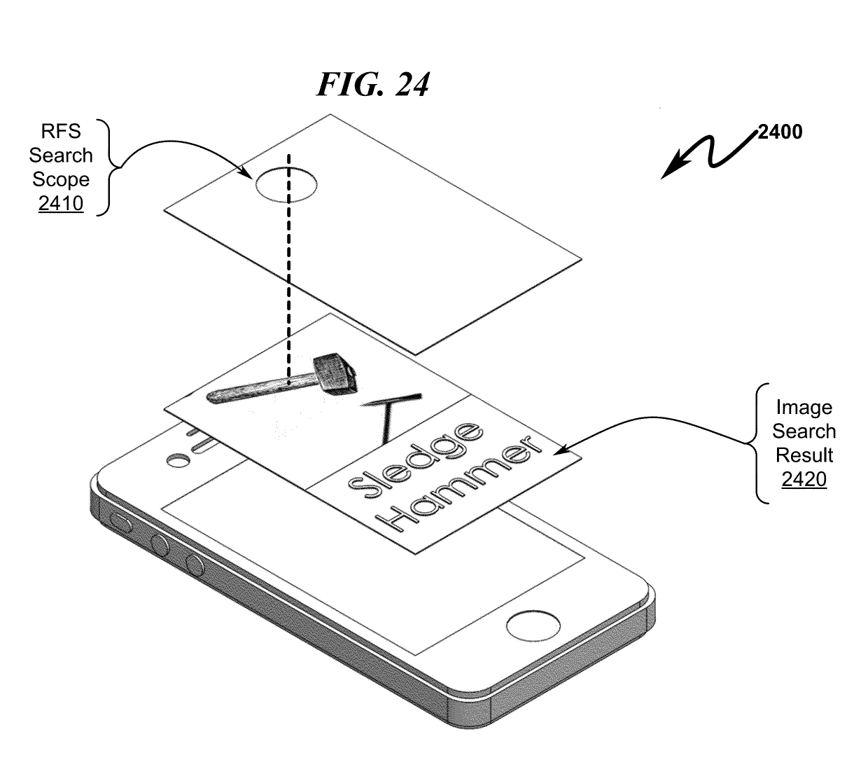

A visual example of dynamic hyperlinking as taught by the present invention is generally depicted in FIG. 17 (1700)-FIG. 24 (2400). Here a MCD as applied to a mobile phone is generally depicted in which a RVS is displayed and a RFS is selected. Once selected, the RFS is then transmitted to the HCS to identify the selected image and dynamically generate a hyperlink to a web page on which information regarding the selected item is displayed. In this example a variety of hammers are depicted, but the concept may be applied to any visual image that is present within the RVS, including stills and a variety of video images. Selection of the RFS may occur using a variety of methodologies that are non-exclusively described below.

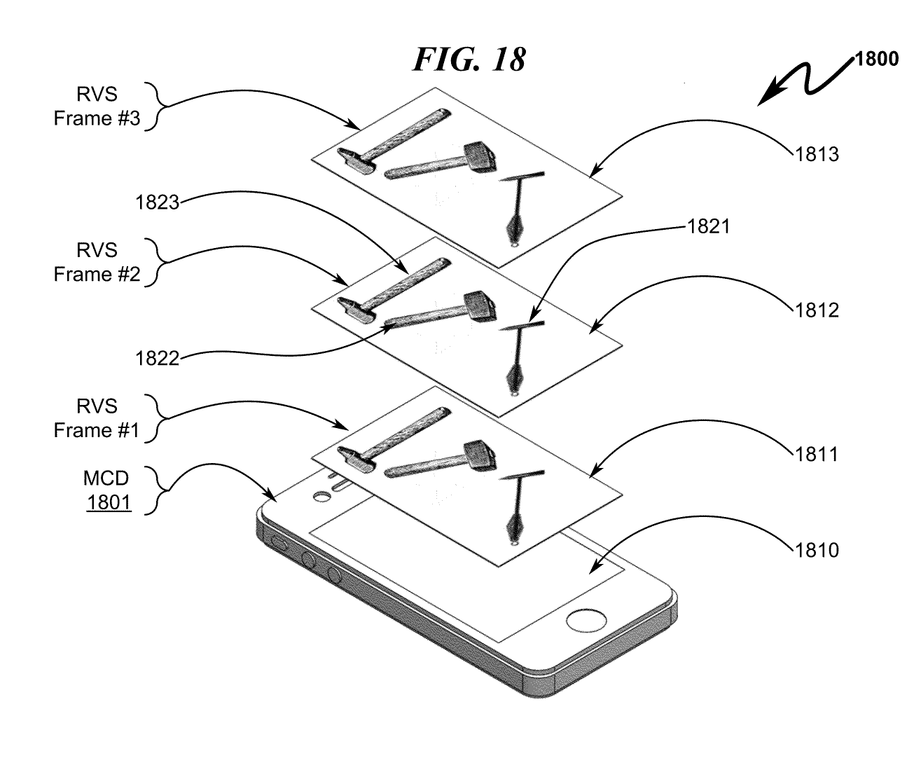

As generally depicted in FIG. 17 (1700)-FIG. 18 (1800), a MCD (1701, 1801) (generically depicted as a mobile phone) contains a display (1710, 1810) in which a number of RVS video frames (1711, 1712, 1713, 1811, 1812, 1813) are displayed in time sequence. These RVS video frames (1711, 1712, 1713, 1811, 1812, 1813) represent streaming video that is transmitted from the HCS to the MCD and interpreted for display by a thin client application (TCA) operating on the MCD. Within these RVS video frames (1711, 1712, 1713, 1811, 1812, 1813) a number of objects (1721, 1722, 1723, 1821, 1822, 1823) may be displayed that may correspond to any number of sub-images depicted within the RVS.

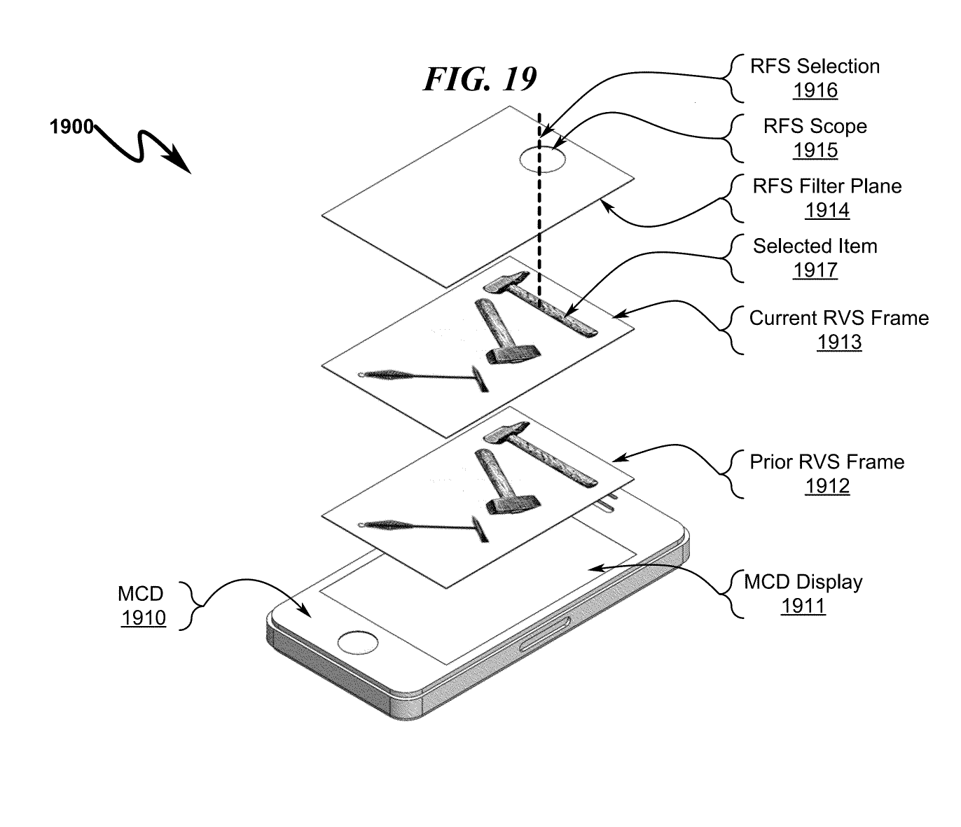

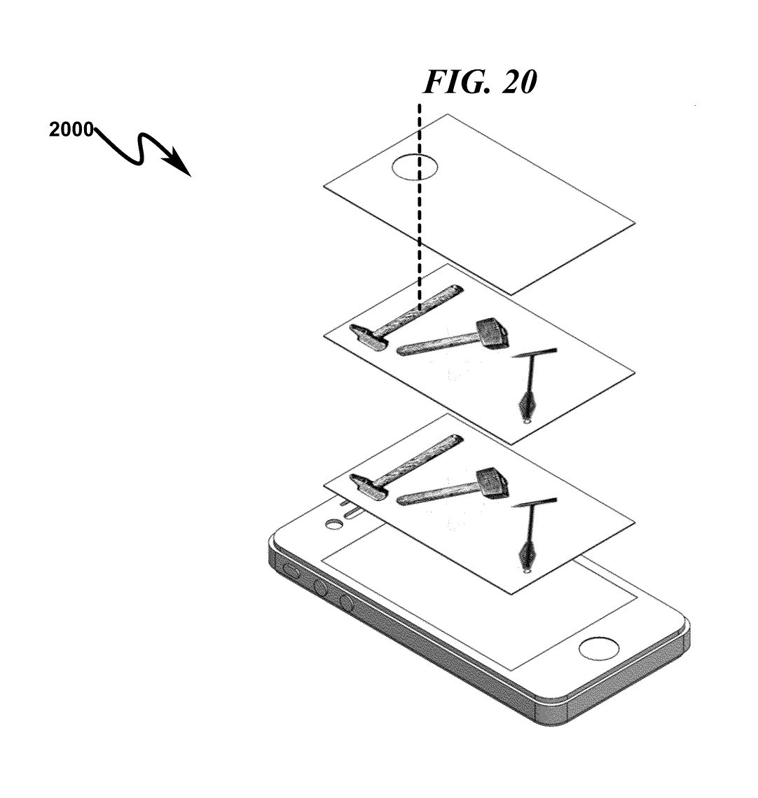

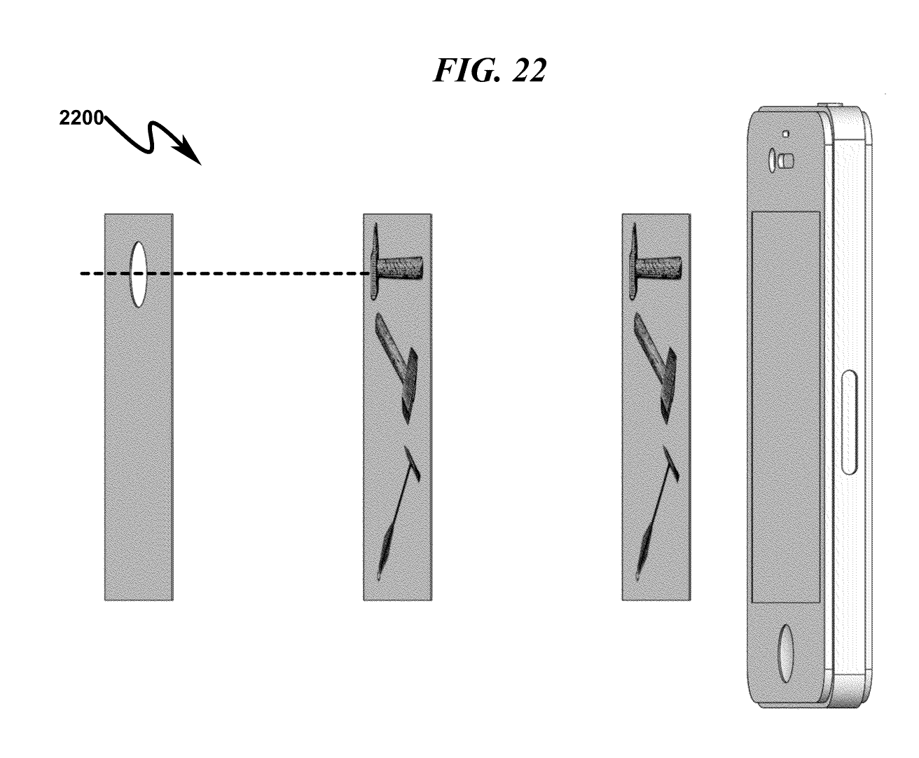

As generally depicted in FIG. 19 (1900)-FIG. 22 (2200), at any time the TCA may allow the user interfacing with the MCD (1910) to select an item from a particular RVS video frame using any of a number of RFS selection techniques described below. As depicted in this diagram, The MCD display (1911) may present prior (1911) and current (1913) RVS frame images as previously described. A RFS filter plane (1914) may contain one or more selected RFS scopes (1915) that provide selection criteria (1916) and identify one or more items or objects (1917) on the current (1913) or previous (1912) RVS video frames. Once the object (1917) is identified, RFS information identifying the object (1917) is transmitted to the HCS that then performs a dynamic hyperlink search of known images or a web search over the Internet for matching images. FIG. 20 (2000) provides another perspective view of the MCD and associated RVS frames and RFS filter plane.

Consistent with the definition of the RFS in this disclosure, a FrameID associated with the current (1913) and/or previous (1912) RVS frame may be sent to the HCS in conjunction with other RFS information identifying the scope of the image search to be performed by the HCS when executing the dynamic hyperlink associated with the selected item (1917) sub-image. The exact RFS content will be application specific, although several preferred embodiments of this communication between the MCD and the HCS are presented below in more detail.

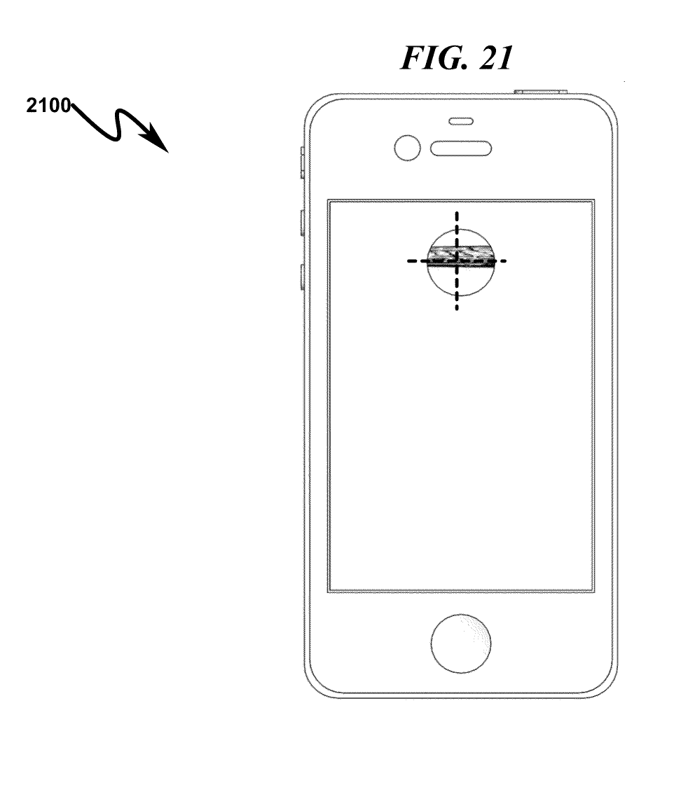

FIG. 21 (2100) provides a top view of the RFS filter plane and indicates a cross-hair that allows determination of the item that is to be selected using the specified RFS selection criterion (a radius circle in this exemplary instance selected using hand gestures).

FIG. 22 (2200) provides additional detail with a side perspective view showing the relationship between the various RVS planes and the RFS filter plane.

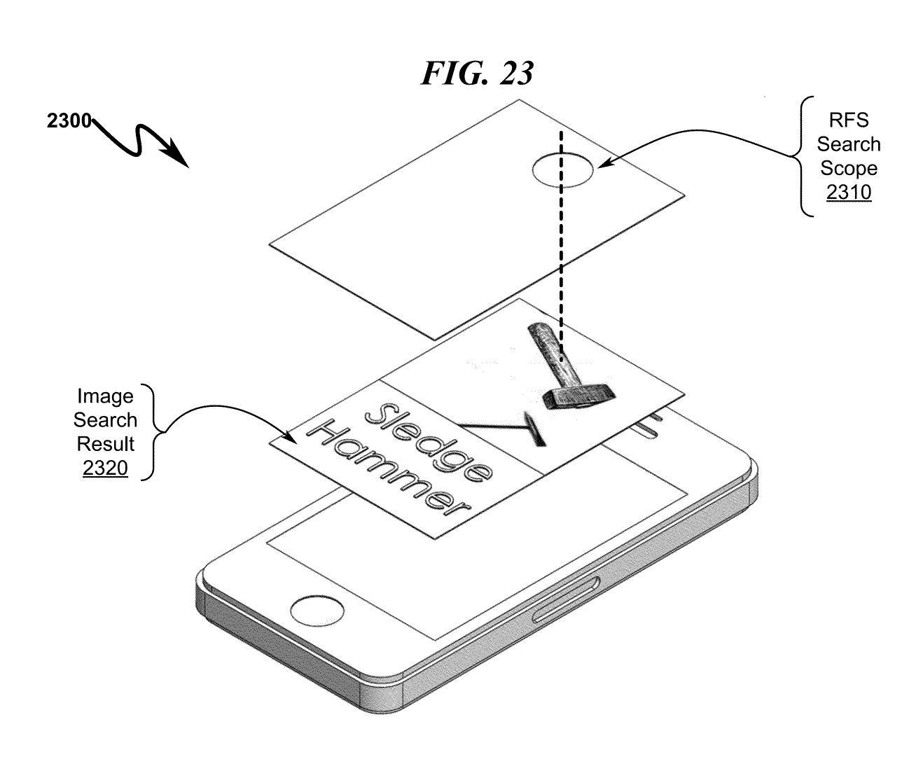

FIG. 23 (2300) and FIG. 24 (2400) provide exemplary detail of how the RFS search scope (2310, 2410) may be analyzed by the HCS and result in a search result (2320, 2420) that is displayed on the MCD display as an overlay or possibly a hyperlinked web page that may be used to further investigate the selected item. These search results (2320, 2420) in some preferred embodiments may include web pages that provide for purchasing items matching the image description provided in the RFS search scope (2310, 2410). Note that an Internet web hyperlink may be associated with the text in some preferred embodiments that links to a particular web page. Alternatives to this may include display of a web page depicting the identified item or a list of image or web search results corresponding to the selected sub-image.

It should be noted that because of the nature of the RVS data stream, the searching may occur based on previously transmitted RVS data or in some circumstances with video frames that are currently being transmitted or which may be queued for transmission to the MCD. In all of these circumstances the image hyperlinking performed by the HCS is dynamic and performed in real-time.

### RFS Detail (2500)-(3200)

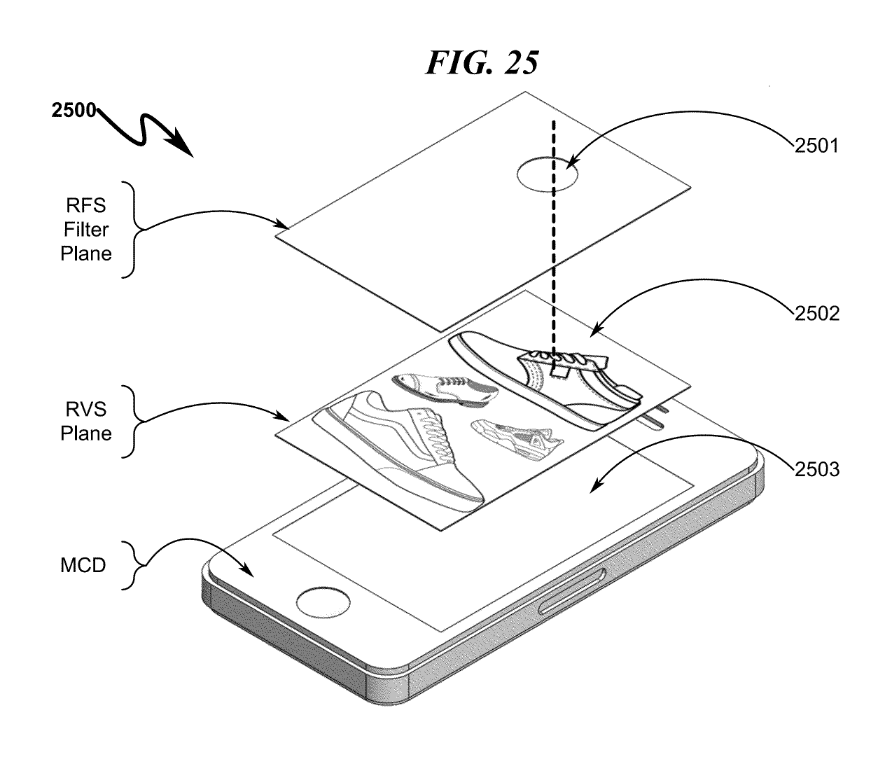

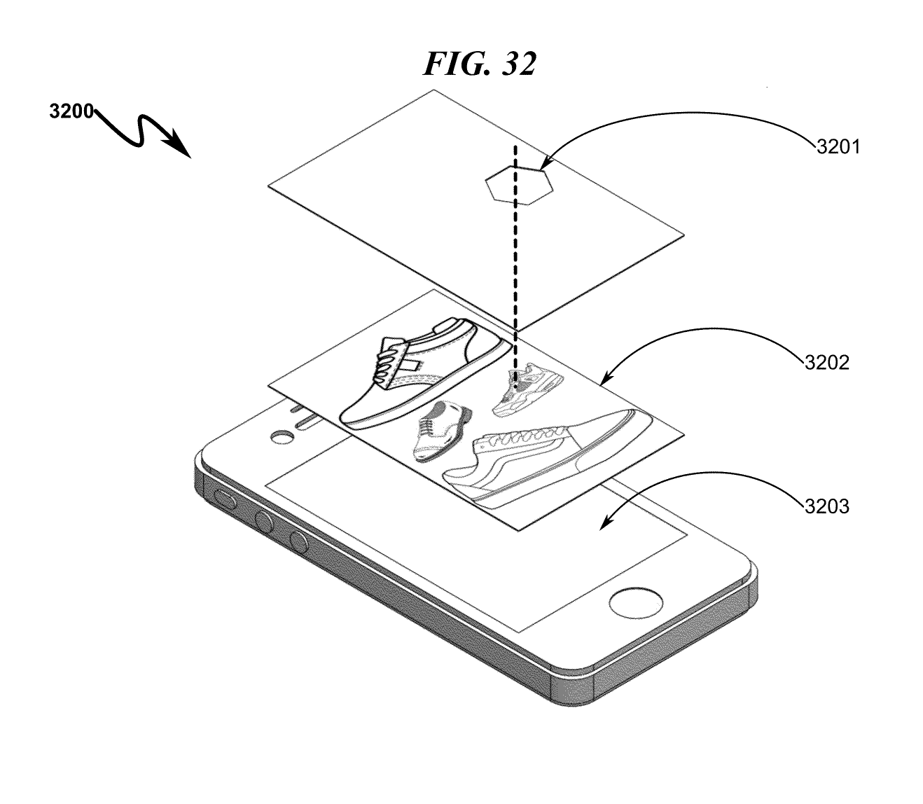

FIG. 25 (2500)-FIG. 32 (3200) provide additional detail on a variety of RVS frame scope (RFS) information from user gestures or other user input to the MCD display that may be collected by the thin client application (TCA) operating under control of the MCD. The examples provided depict a mobile phone application context but may be equally applied to any MCD display context. In each example, the mobile phone is depicted along with one intermediate plane of the RVS video stream and the corresponding RFS identification methodology depicted as a separate top filtering plane that is applied to the RVS video stream plane. The cutout presented in the top plane represents the RFS information that is transmitted to the HCS for hyperlink search processing. The depicted RVS video content has been chosen arbitrarily to indicate a variety of shoes, but could equally be any other object presented in the RVS and may include dynamically displayed items in the display such as items worn by individuals in the RVS or other objects to which the RFS identification process is applied.

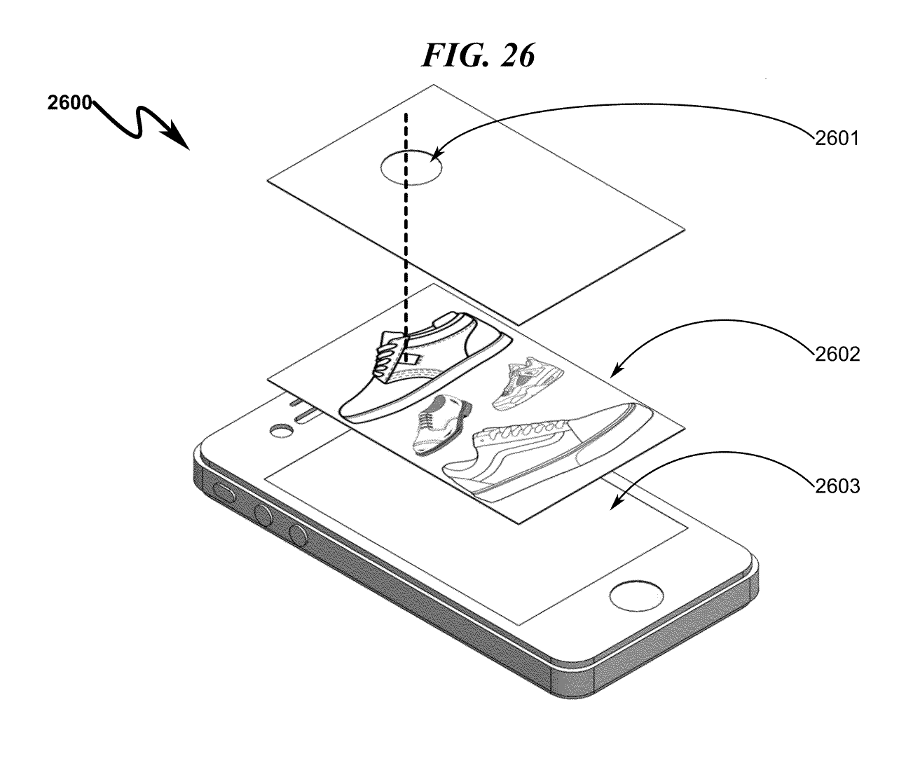

As generally depicted in FIG. 25 (2500)-FIG. 26 (2600), a RFS comprising an Image Origin Reference (IOR) (2501, 2601) may be used in which the user selects a coordinate on the RVS (2502, 2602) presented on the MCD display (2503, 2603) that is associated with either a fixed radial distance or a radial distance selected by the user via a gesture or other MCD input.

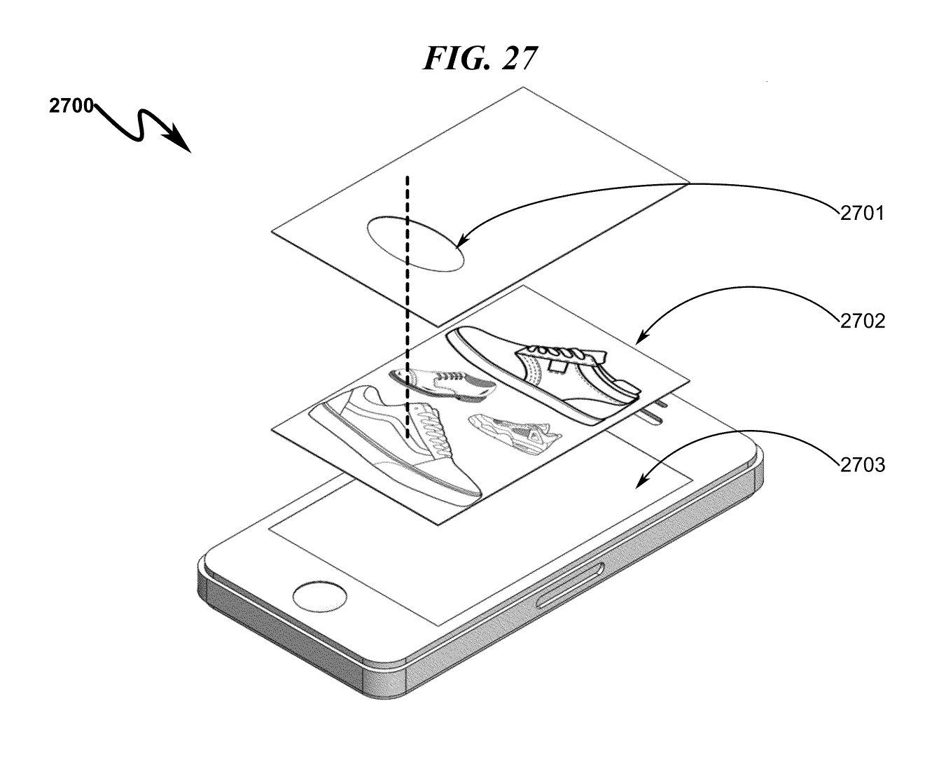

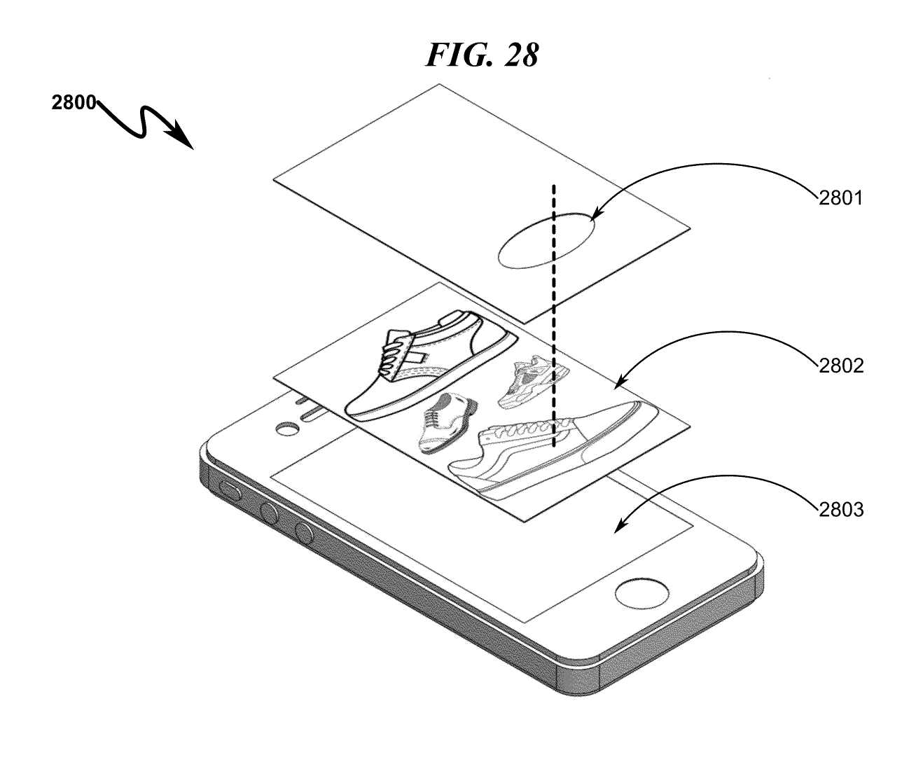

As generally depicted in FIG. 27 (2700)-FIG. 28 (2800), a RFS comprising an Image Elliptical Region (IER) (2701, 2801) may be used in which the user selects a coordinate on the RVS (2702, 2802) presented on the MCD display (2703, 2803) that is associated with either a fixed elliptical shape or an ellipses perimeter selected by the user via a gesture or other MCD input.

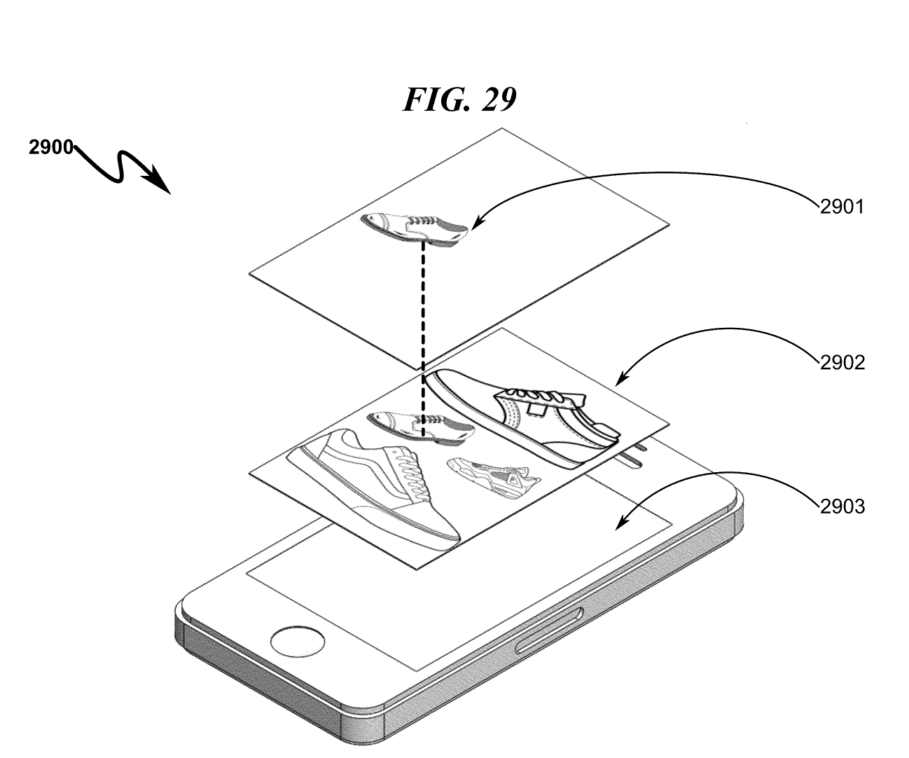

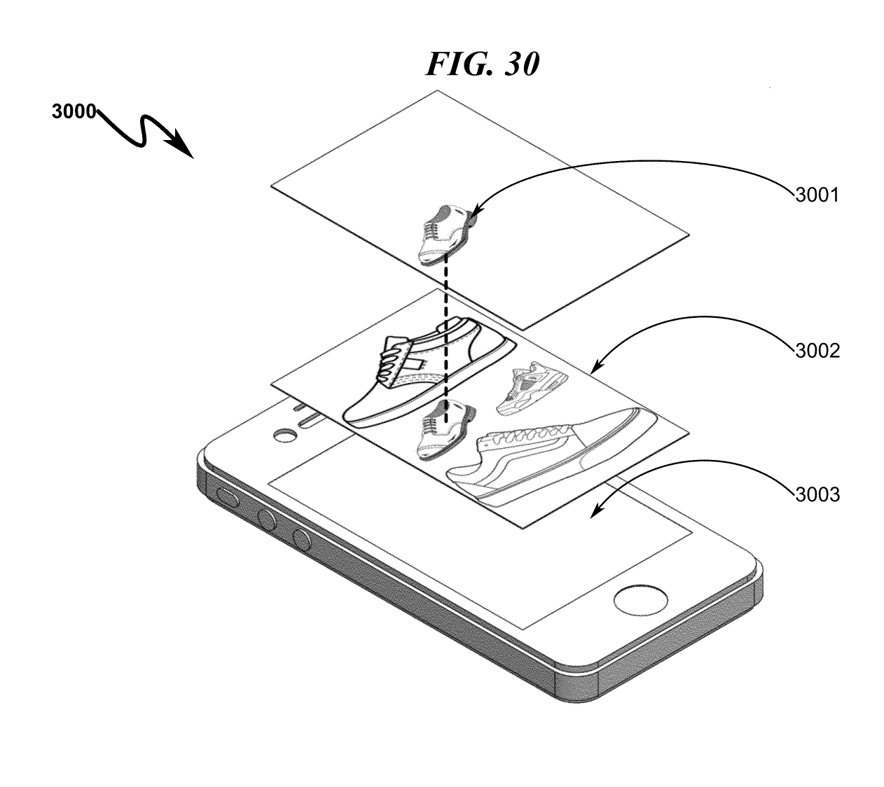

As generally depicted in FIG. 29 (2900)-FIG. 30 (3000), a RFS comprising an Image Peripheral Outline (IPO) (2901, 3001) may be used in which the user selects an item on the RVS (2902, 3002) presented on the MCD display (2903, 3003) and the HCS (or optionally the MCD) automatically selects a perimeter edge of the image selected to determine the extent of the RFS. Here the peripheral edge of the selected item is defined using differentials in image intensity and this periphery is then transmitted to the HCS to identify the selected image portion. In the depicted example, if the user selects the shoe as depicted on the MCD display (2903, 3003) the shoe outline will be selected as representative of the RFS and the outer peripheral outline of this outline will be transmitted to the HCS for processing. This outline selection process may take many forms, but will generally include a variety of well-known edge detection methodologies utilized in conventional image processing and well known to those skilled in the art.

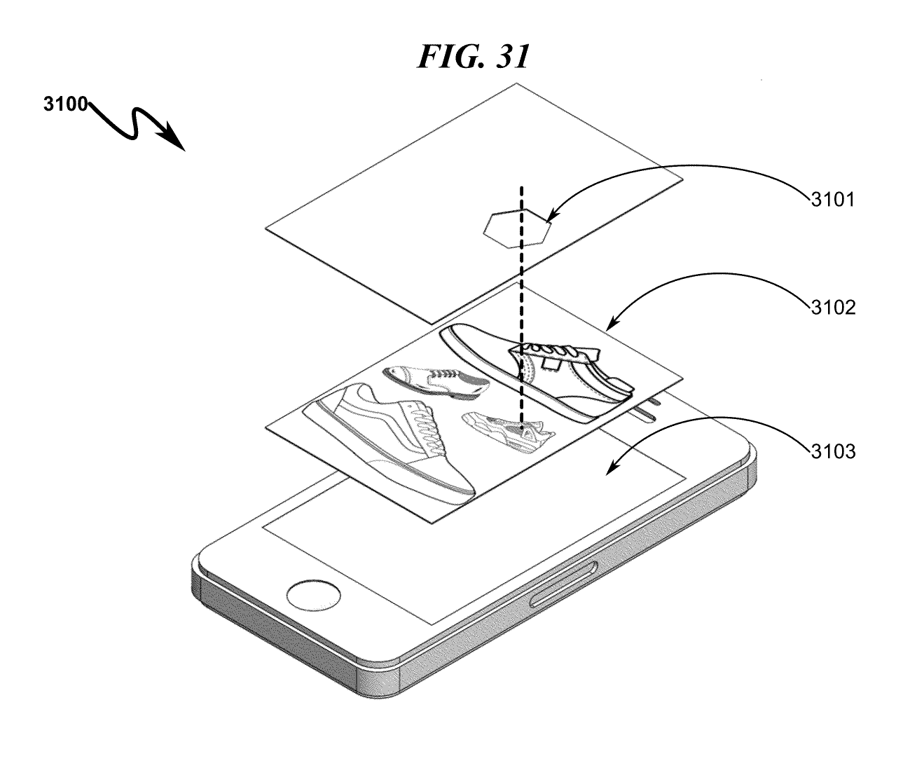

As generally depicted in FIG. 31 (3100)-FIG. 32 (3200), a RFS comprising an Image Polygon Region (IPR) (3101, 3201) may be used in which the user defines a perimeter outline on the RVS (3102, 3202) presented on the MCD display (3103, 3203) to determine the extent of the RFS. The HCS then processes the image contained within the selected polygon region by referencing previously transmitted RVS image data corresponding to the selected perimeter region. The polygon region may be an arbitrary polygon having an arbitrary number of edges of arbitrary length and orientation, or may be any form of regular polygon as depicted in the figure.

In any of the RFS selection methodologies described above embodiments of the present invention may exist in which the MCD defines a sub-image within the displayed RVS as displayed on the MCD that corresponds to the selected sub-region of the MCD display. This sub-image may be then transmitted in binary form to the HCS as the image to be matched in the hyperlinking process. As this requires a significant amount of binary data to be transmitted to the HCS, these embodiments are not considered best mode in many circumstances, but may be used in some embodiments to minimize the computational effort of the HCS and/or reduce the need for the HCS to maintain a history of the RVS in which a FrameID is used to select a particular video frame to which the RFS references. Thus, in these alternate embodiments, the RFS is self-indexing and does not require the transmission of a FrameID to the HCs in order to perform the hyperlinking match function against either the known image database (KID) or to perform searching against images on the Internet.

### Touch-to-Order (TTO) Application

The present invention may in some embodiments used to implement a “touch-to-order (TTO)” functionality within the context of any RVS data streamed to the MCD. The concept of touch-to-order (TTO) relies upon a video streaming TCA client application that receives and renders video and also receives input to a mobile device (including laptops) but is not limited such devices. The application may reside on other smart devices that have the capabilities for viewing video streams and accepting user inputs.

The premise behind touch-to-order is such that a client application will be placed in a mode or state by which it can receive input events by way of an overlay (while still processing/rendering video) that may capture coordinates from images while watching a video stream when a user touches or clicks an area of the screen. The image information, along with touch or click coordinates, and elliptical information surrounding the x, y coordinates may be sent to the streaming service (server) for further image analytical processing. The server providing the video streaming service may contain customized High Performance Computing hardware for processing the compute intensive transcoding of images and video or alternatively may utilize other computing means. The server will listen for, or be aware of such an event coming from the TCA client application in order to process the event further. Further processing may require but is not limited to image analytics, object identification, product identification, user bias input, previously selected items, and/or other algorithms related to unique item identification.

Further processing may include connecting to an e-commerce platform after identification for the purpose of making a purchase. As an example, during a streaming video session a user may see an image of a professional athlete playing golf when they realize they really like the shoes that the athlete is wearing. The user could simply touch the shoe area of the video, the image information will be sent to the remote host server, processed, and linked to an online store with the capability to purchase the item or items placed in a cart for review before or after the video has completed.

Another method may exist for instant purchase with a Picture-in-Picture (PIP) scenario where a user may continue to watch the streaming video but may be presented with an overlapping inter-window providing a mechanism for purchasing an identified item using e-commerce platform.

### System Summary

The present invention system anticipates a wide variety of variations in the basic theme of construction, but can be generalized as a real-time dynamic hyperlinking system comprising:

(a) host computer system (HCS);

(b) mobile computing device (MCD); and

(c) computer communication network (CCN);

wherein
the HCS is configured to execute host operating system software (HOS) machine instructions read from a computer readable storage;
the HOS further comprises virtualized graphical user interface (VUI) device driver machine instructions read from a computer readable storage;
the VUI is configured to virtualize the graphical user experience (GEX) and user input experience (UEX) associated with host application software (HAS) executed on the HCS;
the VUI is configured to translate the GEX into a remote video stream (RVS);
the HCS is configured to transmit the RVS to the MCD over the CCN;
the MCD further comprises a thin client application (TCA) further comprising machine instructions implementing a graphics experience mapper (GEM) and user experience mapper (UEM);
the GEM is configured to receive the RVS and present the RVS to a display on the MCD;
the UEM is configured to accept user input data (UID) entered on the MCD and translate the UID in real-time to a RVS frame scope (RFS) describing a portion of the RVS displayed on the MCD;
the TCA is configured to transmit the RFS to the HCS through the CCN;
the HCS is configured to receive the RFS from the TCA and create a search image (SIM) corresponding to image data in the RVS identified by the RFS;
the HCS is configured to match the SIM to a reference image (RIM); and
the HCS is configured to trigger a hyperlink reference corresponding to the RIM and dynamically insert data from the hyperlink reference into the GEX.

This general system summary may be augmented by the various elements described herein to produce a wide variety of invention embodiments consistent with this overall design description.

### Method Summary

The present invention method anticipates a wide variety of variations in the basic theme of implementation, but can be generalized as a real-time dynamic hyperlinking method comprising:
(1) With a host computer system (HCS), converting a virtual video display to a remote video stream (RVS) comprising a video frame ID (FID) and video frame data (VFD);
(2) With the HCS, streaming the RVS video content from the HCS to a mobile computing device (MCD) running a thin client application (TCA);
(3) With the TCA on the MCD, translating the RVS into a real-time visual display presented on the MCD;
(4) With the TCA on the MCD, entering user specified region selection information (RSI) within a RVS frame contained within the RVS;
(5) With the TCA on the MCD, transmitting combined FrameID and region selection information (RSI) as a region frame scope (RFS) to the HCS;
(6) With the HCS, extracting a search image (SIM) from previously transmitted RVS data using the RFS;
(7) With the HCS, comparing the search image (SIM) against a reference image (RIM)); and
(8) With the HCS, triggering a hyperlink reference corresponding to the RIM and dynamically inserting data from the hyperlink reference into the GEX.

This general method summary may be augmented by the various elements described herein to produce a wide variety of invention embodiments consistent with this overall design description.

### System/Method Variations

The present invention anticipates a wide variety of variations in the basic theme of construction. The examples presented previously do not represent the entire scope of possible usages. They are meant to cite a few of the almost limitless possibilities.

This basic system and method may be augmented with a variety of ancillary embodiments, including but not limited to:
An embodiment wherein the RFS comprises a FrameID (FID) and region selection information (RSI).
An embodiment wherein the RFS comprises region selection information (RSI) comprises an Image Origin Reference (IOR) that defines a position and radial distance in the RVS.
An embodiment wherein the RFS comprises region selection information (RSI) comprises an Image Elliptical Region (IER) that defines a position and an elliptical region in the RVS.
An embodiment wherein the RFS comprises region selection information (RSI) comprises an Image Peripheral Outline (IPO) that defines a peripheral image outline in the RVS.
An embodiment wherein the RFS comprises region selection information (RSI) comprises an Image Polygon Region (IPR) that defines a polygon in the RVS.
An embodiment wherein the RFS comprises region selection information (RSI) comprises an Image Binary Region (IBR) that defines a region of the RVS comprising binary image data.
An embodiment wherein the RIM comprises a known image database (KID).
An embodiment wherein the RIM comprises Internet search images (ISI) produced as a result of an Internet search.
An embodiment wherein the dynamic data insertion comprises activation of a web browser using the hyperlink reference.

One skilled in the art will recognize that other embodiments are possible based on combinations of elements taught within the above invention description.

### Generalized Computer Usable Medium

In various alternate embodiments, the present invention may be implemented as a computer program product for use with a computerized computing system. Those skilled in the art will readily appreciate that programs defining the functions defined by the present invention can be written in any appropriate programming language and delivered to a computer in many forms, including but not limited to: (a) information permanently stored on non-writeable storage media (e.g., read-only memory devices such as ROMs or CD-ROM disks); (b) information alterably stored on writeable storage media (e.g., hard disks and USB thumb drives); and/or (c) information conveyed to a computer through communication media, such as a local area network, a telephone network, or a public network such as the Internet. When carrying computer readable instructions that implement the present invention methods, such computer readable media represent alternate embodiments of the present invention.

As generally illustrated herein, the present invention system embodiments can incorporate a variety of computer readable media that comprise computer usable medium having computer readable code means embodied therein. One skilled in the art will recognize that the software associated with the various processes described herein can be embodied in a wide variety of computer accessible media from which the software is loaded and activated. Pursuant to In re Beauregard, 35 USPQ2d 1383 (U.S. Pat. No. 5,710,578), the present invention anticipates and includes this type of computer readable media within the scope of the invention. Pursuant to In re Nuijten, 500 F.3d 1346 (Fed. Cir. 2007) (U.S. patent application Ser. No. 09/211,928), the present invention scope is limited to computer readable media wherein the media is both tangible and non-transitory.

### CONCLUSION

A system and method enabling real-time dynamic hyperlinking of software applications and resources within mobile devices has been disclosed. The system/method virtualizes the graphical user experience (GEX) and user input experience (UEX) that comprise the graphical user interface (GUI) for host application software (HAS) running on a host computer system (HCS). The virtualized GUI (VUI) GEX component is converted to a remote video stream (RVS) and communicated to a remote mobile computing device (MCD) over a computer communication network (CCN). A MCD thin client application (TCA) receives the RVS and presents this GEX content on the MCD display using a graphics experience mapper (GEM). A RVS frame scope (RFS) of real-time user-selected RVS frame regions may be dynamically transmitted by the TCA to the HCS which then translates the associated RFS into a hyperlink associated with known and/or searched images that are matched to the RFS.

### Claims Interpretation

The following rules apply when interpreting the CLAIMS of the present invention:
The CLAIM PREAMBLE should be considered as limiting the scope of the claimed invention.
“WHEREIN” clauses should be considered as limiting the scope of the claimed invention.
“WHEREBY” clauses should be considered as limiting the scope of the claimed invention.
“ADAPTED TO” clauses should be considered as limiting the scope of the claimed invention.
“ADAPTED FOR” clauses should be considered as limiting the scope of the claimed invention.
The term “MEANS” specifically invokes the means-plus-function claims limitation recited in 35 U.S.C. §112(f) and such claim shall be construed to cover the corresponding structure, material, or acts described in the specification and equivalents thereof.
The phrase “MEANS FOR” specifically invokes the means-plus-function claims limitation recited in 35 U.S.C. §112(f) and such claim shall be construed to cover the corresponding structure, material, or acts described in the specification and equivalents thereof.
The phrase “STEP FOR” specifically invokes the step-plus-function claims limitation recited in 35 U.S.C. §112(f) and such claim shall be construed to cover the corresponding structure, material, or acts described in the specification and equivalents thereof.
The phrase “AND/OR” in the context of an expression “X and/or Y” should be interpreted to define the set of “(X and Y)” in union with the set “(X or Y)” as interpreted by Ex Parte Gross (USPTO Patent Trial and Appeal Board, Appeal 2011-004811, Ser. No. 11/565,411, (“‘and/or’ covers embodiments having element A alone, B alone, or elements A and B taken together”).
The claims presented herein are to be interpreted in light of the specification and drawings presented herein with sufficiently narrow scope such as to not preempt any abstract idea.
The claims presented herein are to be interpreted in light of the specification and drawings presented herein with sufficiently narrow scope such as to not preclude every application of any idea.
The claims presented herein are to be interpreted in light of the specification and drawings presented herein with sufficiently narrow scope such as to preclude any basic mental process that could be performed entirely in the human mind.
The claims presented herein are to be interpreted in light of the specification and drawings presented herein with sufficiently narrow scope such as to preclude any process that could be performed entirely by human manual effort.

### Claims

Although a preferred embodiment of the present invention has been illustrated in the accompanying drawings and described in the foregoing Detailed Description, it will be understood that the invention is not limited to the embodiments disclosed, but is capable of numerous rearrangements, modifications, and substitutions without departing from the spirit of the invention as set forth and defined by the following claims.

What is claimed is:

1. A real-time dynamic hyperlinking system comprising:
(a) host computer system (HCS);
(b) mobile computing device (MCD); and
(c) computer communication network (CCN);
wherein
said HCS is configured to execute host operating system software (HOS) machine instructions read from a computer readable storage;
said HOS further comprises virtualized graphical user interface (VUI) device driver machine instructions read from a computer readable storage;
said VUI is configured to virtualize the graphical user experience (GEX) and user input experience (UEX) associated with host application software (HAS) executed on said HCS;
said VUI is configured to translate said GEX into a remote video stream (RVS);
said HCS is configured to transmit said RVS to said MCD over said CCN;
said MCD further comprises a thin client application (TCA) further comprising machine instructions implementing a graphics experience mapper (GEM) and user experience mapper (UEM);
said GEM is configured to receive said RVS and present said RVS to a display on said MCD;
said UEM is configured to accept user input data (UID) entered on said MCD and translate said UID in real-time to a RVS frame scope (RFS) describing a portion of said RVS displayed on said MCD;
said TCA is configured to transmit said RFS to said HCS through said CCN;
said HCS is configured to receive said RFS from said TCA and create a search image (SIM) corresponding to image data in said RVS identified by said RFS;
said HCS is configured to match said SIM to a reference image (RIM); and
said HCS is configured to trigger a hyperlink reference corresponding to said RIM and dynamically insert data from said hyperlink reference into said GEX.

2. The real-time dynamic hyperlinking system of claim 1 wherein said RFS comprises a FrameID (FID) and region selection information (RSI).

3. The real-time dynamic hyperlinking system of claim 1 wherein said RFS comprises region selection information (RSI) comprises an Image Origin Reference (IOR) that defines a position and radial distance in said RVS.

4. The real-time dynamic hyperlinking system of claim 1 wherein said RFS comprises region selection information (RSI) comprises an Image Elliptical Region (IER) that defines a position and an elliptical region in said RVS.

5. The real-time dynamic hyperlinking system of claim 1 wherein said RFS comprises region selection information (RSI) comprises an Image Peripheral Outline (IPO) that defines a peripheral image outline in said RVS.

6. The real-time dynamic hyperlinking system of claim 1 wherein said RFS comprises region selection information (RSI) comprises an Image Polygon Region (IPR) that defines a polygon in said RVS.

7. The real-time dynamic hyperlinking system of claim 1 wherein said RFS comprises region selection information (RSI) comprises an Image Binary Region (IBR) that defines a region of said RVS comprising binary image data.

8. The real-time dynamic hyperlinking system of claim 1 wherein said RIM comprises a known image database (KID).

9. The real-time dynamic hyperlinking system of claim 1 wherein said RIM comprises Internet search images (ISI) produced as a result of an Internet search.

10. The real-time dynamic hyperlinking system of claim 1 wherein said dynamic data insertion comprises activation of a web browser using said hyperlink reference.

11. A real-time dynamic hyperlinking method comprising:
(1) With a host computer system (HCS), converting a virtual video display to a remote video stream (RVS) comprising a video frame ID (FID) and video frame data (VFD);
(2) With said HCS, streaming said RVS video content from said HCS to a mobile computing device (MCD) running a thin client application (TCA);
(3) With said TCA on said MCD, translating said RVS into a real-time visual display presented on said MCD;
(4) With said TCA on said MCD, entering user specified region selection information (RSI) within a RVS frame contained within said RVS;
(5) With said TCA on said MCD, transmitting combined FrameID and region selection information (RSI) as a region frame scope (RFS) to said HCS;
(6) With said HCS, extracting a search image (SIM) from previously transmitted RVS data using said RFS;
(7) With said HCS, comparing said search image (SIM) against a reference image (RIM)); and
(8) With said HCS, triggering a hyperlink reference corresponding to said RIM and dynamically inserting data from said hyperlink reference into said GEX.

12. The real-time dynamic hyperlinking method of claim 11 wherein said RFS comprises a FrameID (FID) and region selection information (RSI).

13. The real-time dynamic hyperlinking method of claim 11 wherein said RFS comprises region selection information (RSI) comprises an Image Origin Reference (IOR) that defines a position and radial distance in said RVS.

14. The real-time dynamic hyperlinking method of claim 11 wherein said RFS comprises region selection information (RSI) comprises an Image Elliptical Region (IER) that defines a position and an elliptical region in said RVS.

15. The real-time dynamic hyperlinking method of claim 11 wherein said RFS comprises region selection information (RSI) comprises an Image Peripheral Outline (IPO) that defines a peripheral image outline in said RVS.

16. The real-time dynamic hyperlinking method of claim 11 wherein said RFS comprises region selection information (RSI) comprises an Image Polygon Region (IPR) that defines a polygon in said RVS.

17. The real-time dynamic hyperlinking method of claim 11 wherein said RFS comprises region selection information (RSI) comprises an Image Binary Region (IBR) that defines a region of said RVS comprising binary image data.

18. The real-time dynamic hyperlinking method of claim 11 wherein said RIM comprises a known image database (KID).

19. The real-time dynamic hyperlinking method of claim 11 wherein said RIM comprises Internet search images (ISI) produced as a result of an Internet search.

20. The real-time dynamic hyperlinking method of claim 11 wherein said dynamic data insertion comprises activation of a web browser using said hyperlink reference.

21. A tangible non-transitory computer usable medium having computer-readable program code means comprising a real-time dynamic hyperlinking method comprising:
(1) With a host computer system (HCS), converting a virtual video display to a remote video stream (RVS) comprising a video frame ID (FID) and video frame data (VFD);
(2) With said HCS, streaming said RVS video content from said HCS to a mobile computing device (MCD) running a thin client application (TCA);
(3) With said TCA on said MCD, translating said RVS into a real-time visual display presented on said MCD;
(4) With said TCA on said MCD, entering user specified region selection information (RSI) within a RVS frame contained within said RVS;
(5) With said TCA on said MCD, transmitting combined FrameID and region selection information (RSI) as a region frame scope (RFS) to said HCS;
(6) With said HCS, extracting a search image (SIM) from previously transmitted RVS data using said RFS;
(7) With said HCS, comparing said search image (SIM) against a reference image (RIM)); and
(8) With said HCS, triggering a hyperlink reference corresponding to said RIM and dynamically inserting data from said hyperlink reference into said GEX.

22. The computer usable medium of claim 21 wherein said RFS comprises a FrameID (FID) and region selection information (RSI).

23. The computer usable medium of claim 21 wherein said RFS comprises region selection information (RSI) comprises an Image Origin Reference (IOR) that defines a position and radial distance in said RVS.

24. The computer usable medium of claim 21 wherein said RFS comprises region selection information (RSI) comprises an Image Elliptical Region (IER) that defines a position and an elliptical region in said RVS.

25. The computer usable medium of claim 21 wherein said RFS comprises region selection information (RSI) comprises an Image Peripheral Outline (IPO) that defines a peripheral image outline in said RVS.

26. The computer usable medium of claim 21 wherein said RFS comprises region selection information (RSI) comprises an Image Polygon Region (IPR) that defines a polygon in said RVS.

27. The computer usable medium of claim 21 wherein said RFS comprises region selection information (RSI) comprises an Image Binary Region (IBR) that defines a region of said RVS comprising binary image data.

28. The computer usable medium of claim 21 wherein said RIM comprises a known image database (KID).

29. The computer usable medium of claim 21 wherein said RIM comprises Internet search images (ISI) produced as a result of an Internet search.

30. The computer usable medium of claim 21 wherein said dynamic data insertion comprises activation of a web browser using said hyperlink reference.
